(19) United States
(12) Patent Application Publication
(10) Pub. No.: US 2010/0316392 A1
(43) Pub. Date: Dec. 16, 2010

(54) TUNABLE DISPERSION COMPENSATION APPARATUS, OPTICAL RECEPTION MODULE AND METHOD

(75) Inventor: Miki ONAKA, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/795,958

(22) Filed: Jun. 8, 2010

(30) Foreign Application Priority Data
Jun. 15, 2009 (JP) 2009-142329

(51) Int. Cl. H04B 10/00

(52) U.S. Cl. 398/159

(57) ABSTRACT

An apparatus includes: a first dispersion compensator that is arranged on an optical path between an input port and an output port, that has a dispersion compensation band, and that substantially compensates a chromatic dispersion to signal light by using a variable amount of dispersion compensation, a second dispersion compensator that is arranged on the optical path, that has a dispersion compensation band different from the dispersion compensation band of the first dispersion compensator, and that substantially compensates the chromatic dispersion to the signal light by using a variable amount of dispersion compensation and a controller that controls the first dispersion compensator in accordance with the value of chromatic dispersion to be compensated and that controls the amount of dispersion compensation and the dispersion compensation band in the second dispersion compensator in association with the amount of dispersion compensation in the first dispersion compensator.

### CROSS-REFERENCE TO RELATED APPLICATIONS

This application is based upon and claims the benefit of priority of the prior Japanese Patent Application No. 2009-142329, filed on Jun. 15, 2009, the entire contents of which are incorporated herein by reference.

### FIELD

Various embodiments described herein relate to a tunable dispersion compensation apparatus that performs chromatic dispersion compensation to signal light used in optical communication, to an optical reception module to which the tunable dispersion compensation apparatus is applied and methods.

### BACKGROUND

Signal light that is transmitted and received in optical communication systems and that has a transmission speed of approximately 40 gigabits per second (Gb/s) or higher has a narrow pulse width of, for example, a few picoseconds. Accordingly, signal waveform distortion caused by minor chromatic dispersion of optical fiber used in transmission lines greatly degrades the transmission characteristics of the signal light. In addition, since the chromatic dispersion values of the transmission lines are varied with time along with an environmental variation, such as a variation in temperature, the temporal variation of the chromatic dispersion values also has an adverse effect on the transmission characteristics of the signal light.

Chromatic dispersion compensation techniques are effectively applied to the above-described degradation of the transmission characteristics caused by the chromatic dispersion. The chromatic dispersion compensation techniques in related art include an arrangement in which a dispersion compensation fiber is arranged on a transmission line to compensate waveform distortion caused by the chromatic dispersion of the transmission line with the dispersion compensation fiber. By the dispersion compensation fiber, waveform distortion caused by the chromatic dispersion is substantially compensated so that an optical receiver can receive an optical signal in range of a tolerance.

In addition, in the chromatic dispersion compensation of Wavelength Division Multiplexing (WDM) signal light in which multiple signal light beams (channels) having different wavelengths are multiplexed, it is effective not only to arrange dispersion compensation fiber on the optical path on which the WDM signal light is propagated but also to provide a tunable dispersion compensator (TDC) on each of the optical paths on which demultiplexed signal light beams having a single wavelength are propagated in an optical reception apparatus that demultiplexes the WDM signal light transmitted on the optical path and receives the demultiplexed WDM signal light.

The dispersion compensation is preferably performed in the TDC on each optical path in accordance with the wavelength of each signal light beam so as to compensate residual dispersion that cannot be compensated by the dispersion compensation fiber on the optical path (for example, refer to Japanese Patent Application No. 3396270 and Japanese Unexamined Patent Application Publication No. 2005-234264).

The TDC is realized in various arrangements using optical devices including Etalon, Fiber Bragg Grating (FBG), and Virtually Imaged Phased Array (VIPA). The Etalon is an optical device including translucent films formed on both sides of a flat plate. Interference between multiple reflections of light between the translucent films provides periodical loss wavelength characteristics and group delay characteristics. The length of the optical path is mechanically varied or is varied with a varied temperature to vary the amount of chromatic dispersion.

The FBG is a reflector in which the refractive index of the core of optical fiber is periodically varied to form grating where Bragg diffraction is caused to achieve the function of a reflective filter. The time during which the reflected light is returned is varied with the wavelength by gradually varying the pitch of the Bragg diffraction to cause chromatic dispersion. The temperature of the fiber in which the FBG is formed is varied or a stress is applied to the fiber to vary the pitch of the Bragg diffraction in order to vary the amount of chromatic dispersion.

The VIPA is an optical device that uses the Etalon in which a translucent film is formed on one side of a thin glass plate (VIPA plate) and a reflective film is formed on the other side thereof is used as diffraction grating. Light beams that are emitted from the VIPA in different directions in accordance with the wavelengths are reflected by a three-dimensional mirror and the reflected light beams are returned to the VIPA to cause chromatic dispersion. The position of the three-dimensional mirror is shifted to vary the optical distance for every wavelength in order to vary the amount of chromatic dispersion.

The residual dispersion of the WDM signal light of each wavelength, received by the optical reception apparatus described above, tends to increase due to, for example, an increase in the transmission speed, an increase in the transmission distance (transmission span), and/or complication of a photonic network (for example, an optical add-drop structure, a hub structure, and a combination of different kinds of transmission lines). Accordingly, the absolute value of the amount of dispersion compensation for the signal light of each wavelength is increased in the TDC arranged on each optical path of the optical reception apparatus.

In other words, since the reception end receives the burden of an excess or deficiency of the dispersion compensation on the transmission line, each TDC in the optical reception apparatus is required to have a large variable width of the amount of dispersion compensation both in the positive direction and in the negative direction. Exemplary arrangements in the related art realizing the TDC having a larger absolute value of the amount of dispersion compensation include an arrangement in which multiple dispersion compensation elements are arranged in series along the optical path (for example, refer to Japanese Unexamined Patent Application Publication No. 2005-234264 and International Publication No. 01/084749 Pamphlet).

However, the TDC described above has a problem in that the wavelength or the frequency band (hereinafter referred to as a “dispersion compensation band”) in which the dispersion compensation is effectively performed is decreased with the increasing absolute value of the amount of dispersion compensation which makes it difficult to realize preferred transmission characteristics by the dispersion compensation with the TDC.

Specifically, the dispersion compensation band of the TDC corresponds to the frequency band in which group delays are linearly varied with respect to the wavelength or the frequency, and it is important for the dispersion compensation band to be wider than the spectral width of the signal light. In contrast, the broadening of the spectrum of the signal light becomes noticeable with the increasing transmission speed. The dispersion compensation band of the TDC, which is narrower than the spectral width of the signal light, inhibits the spectral components outside the dispersion compensation band from being subjected to the dispersion compensation with a desired precision to cause a degradation in the transmission characteristics of the signal light.

The relationship between the amount of dispersion compensation and the dispersion compensation band of the TDC will now be specifically described.

FIGS. 1A and 1B illustrate examples of group delay characteristics of a TDC in which multiple (five in the examples in FIGS. 1A and 1B) Etalon devices are arranged in series along the optical path. Referring to FIGS. 1A and 1B, a group delay characteristic GD1-5 of the entire TDC is realized by superposition of group delay characteristics GD1 to GD5 of individual Etalon devices. The gradient of the group delay characteristic GD1-5 corresponds to the amount of dispersion compensation.

FIG. 1A is a graph illustrating a case in which the absolute value of the amount of dispersion compensation is small. In this case, for example, adjusting the temperature of each Etalon device makes the interval between the peak wavelengths of the group delay characteristics GD1 to GD5 of the respective Etalon devices relatively wide to reduce the gradient of the group delay characteristic GD1-5 resulting from the superposition. The dispersion compensation band in this state is a frequency band CB in which the group delay characteristic GD1-5 is linearly varied.

FIG. 1B is a graph illustrating a case in which the absolute value of the amount of dispersion compensation is large. In this case, the interval between the peak wavelengths of the group delay characteristics GD1 to GD5 of the respective Etalon devices is made narrower than that in the case in which the absolute value of the amount of dispersion compensation is small to increase the gradient of the group delay characteristic GD1-5 resulting from the superposition. A dispersion compensation band CB′ in this state is narrower than the dispersion compensation band CB in the case in which the absolute value of the amount of dispersion compensation is small.

FIG. 2 illustrates an exemplary variation in the group delay characteristics when the amount of dispersion compensation in a TDC is set to values from +500 ps/nm to +1,500 ps/nm in stages. The example in FIG. 2 indicates that the dispersion compensation band is narrowed with the increasing gradient of the group delay characteristic and the increasing amount of dispersion compensation.

The TDC has problems in that, for example, the insertion loss is increased and a size of the entire TDC is increased, in addition to the problem of the degradation in the transmission characteristics caused by the dispersion compensation band that is narrowed owing to the increase in the absolute value of the amount of dispersion compensation, because the TDC has the arrangement in which the multiple dispersion compensation elements are arranged in series to expand the variable width of the amount of dispersion compensation. The problem of the increase in the insertion loss can be resolved by, for example, adopting an optical amplifier along with the TDC to increase the gain of the optical amplifier. However, it is difficult to resolve the problem of the increase in the size of the entire TDC because there is a trade-off between the request for the increase in the variable width of the amount of dispersion compensation and the request for the decrease in the size of the entire TDC and, thus, it is not easy to concurrently meet both the requirements.

It is particularly important to meet the request for the decrease in the size of the entire TDC in the case in which the TDC is arranged on the optical path corresponding to each wavelength resulting from the demultiplexing in the optical reception apparatus described above. Specifically, in the optical reception apparatus, the mounting space that can be allocated to an optical reception module corresponding to each channel of the WDM signal light that is received is generally restricted by the size of the entire apparatus. Since various functional components including the TDC, an optical amplifier used for compensating the insertion loss of the TDC, and an optical receiver are mounted in the optical reception module of each channel, it may be difficult to mount these functional components in a certain space. Accordingly, it is an important subject to decrease the size of the functional components.

Even if the required functional components is mounted in the certain space, the functional components that are densely mounted may degrade the ventilation in the apparatus to increase the temperature and the temperature may undesirably exceed an allowable temperature set for the functional components. Such a situation causes a problem in that the performance and the reliability of the optical reception apparatus are degraded and also causes a problem in thermal design in that the design of the optical reception apparatus is disabled.

### SUMMARY

According to an embodiment of the invention, an apparatus includes a first dispersion compensator that is arranged on an optical path between an input port and an output port, that has a dispersion compensation band, and that substantially compensates a chromatic dispersion to signal light by using a variable amount of dispersion compensation, and a second dispersion compensator that is arranged on the optical path, that has a dispersion compensation band different from the dispersion compensation band of the first dispersion compensator, and that substantially compensates the chromatic dispersion to the signal light by using a variable amount of dispersion compensation.

The apparatus, according to an embodiment, includes a controller that controls the first dispersion compensator in accordance with a value of chromatic dispersion to be compensated and that controls the amount of dispersion compensation and the dispersion compensation band in the second dispersion compensator in association with an amount of dispersion compensation in the first dispersion compensator.

An object and advantages of the invention will be realized and attained by means of the elements and combinations particularly pointed out in the claims.

It is to be understood that both the foregoing general description and the following detailed description are exemplary and explanatory and are not restrictive of the invention, as claimed. Additional aspects and/or advantages will be set forth in part in the description which follows and, in part, will be apparent from the description, or may be learned by practice of the invention.

### BRIEF DESCRIPTION OF THE DRAWINGS

These and/or other aspects and advantages will become apparent and more readily appreciated from the following description of the embodiments, taken in conjunction with the accompanying drawings of which:

FIGS. 1A and 1B illustrate examples of group delay characteristics of a TDC;

FIG. 2 illustrates an example of a relationship between amounts of dispersion compensation and dispersion compensation bands in a TDC;

FIG. 3 illustrates an example of an arrangement of a tunable dispersion compensation apparatus according to an embodiment of the present invention;

FIG. 4A illustrates exemplary group delay characteristics of a first dispersion compensator and a second dispersion compensator in an embodiment of the present invention;

FIG. 4B illustrates an example of a relationship between dispersion compensation bands of the first dispersion compensator and the second dispersion compensator and a spectrum of signal light in an embodiment of the present invention;

FIG. 5 illustrates another exemplary arrangement concerning a tunable dispersion compensation apparatus according to an embodiment of the present invention;

FIG. 6 illustrates an example of an arrangement of an optical reception module to which a tunable dispersion compensation apparatus according to an embodiment of the present invention is applied;

FIG. 7 specifically illustrates an example of an arrangement of the tunable dispersion compensation apparatus according to an embodiment of the present invention;

FIGS. 8A, 8B and 8C illustrate exemplary group delay characteristics and group delay ripple characteristics of a first dispersion compensator in an embodiment of the present invention;

FIGS. 9A, 9B and 9C illustrate exemplary group delay characteristics and group delay ripple characteristics of a second dispersion compensator corresponding to the examples in FIGS. 8A to 8C;

FIGS. 10A, 10B and 10C illustrate exemplary group delay characteristics and group delay ripple characteristics in the entire tunable dispersion compensation apparatus, corresponding to the combination of the examples in FIGS. 8A, 8B and 8C and FIGS. 9A, 9B and 9C;

FIGS. 11A, 11B, 11C and 11D illustrate periodicity of the group delay characteristics of the first and second dispersion compensators in an embodiment of the present invention;

FIG. 12 illustrates an example of an operation to set the first and second dispersion compensators in the optical reception module in FIG. 6;

FIGS. 13A, 13B and 13C specifically illustrate a relationship between an amount of dispersion compensations and dispersion compensation bands of the first and second dispersion compensators in an embodiment of the present invention;

FIGS. 14A and 14B illustrate an example of a relationship between a group delay characteristics and dispersion compensation bands of the first and second dispersion compensators, corresponding to setting values of amounts of dispersion compensation in an embodiment of the present invention;

FIG. 15 illustrates an example of a relationship in an entire tunable dispersion compensation apparatus between a group delay characteristics and dispersion compensation bands;

FIG. 16 illustrates an example of a control operation in an FBG part corresponding to a longer wavelength side in an embodiment of the present invention;

FIG. 17 illustrates another exemplary arrangement concerning a tunable dispersion compensation apparatus according to an embodiment of the present invention;

FIG. 18 illustrates another exemplary arrangement concerning a tunable dispersion compensation apparatus according to an embodiment of the present invention;

FIGS. 19A, 19B, 19C and 19D illustrate exemplary group delay characteristics of first and second dispersion compensators in a tunable dispersion compensation apparatus in FIG. 18;

FIG. 20 illustrates an example in which guard bands are provided near both ends of a dispersion compensation band of the first dispersion compensator;

FIG. 21 illustrates an arrangement of an application example concerning an optical reception module in FIG. 6; and

FIG. 22 illustrates an exemplary specific structure of a second dispersion compensator in FIG. 21.

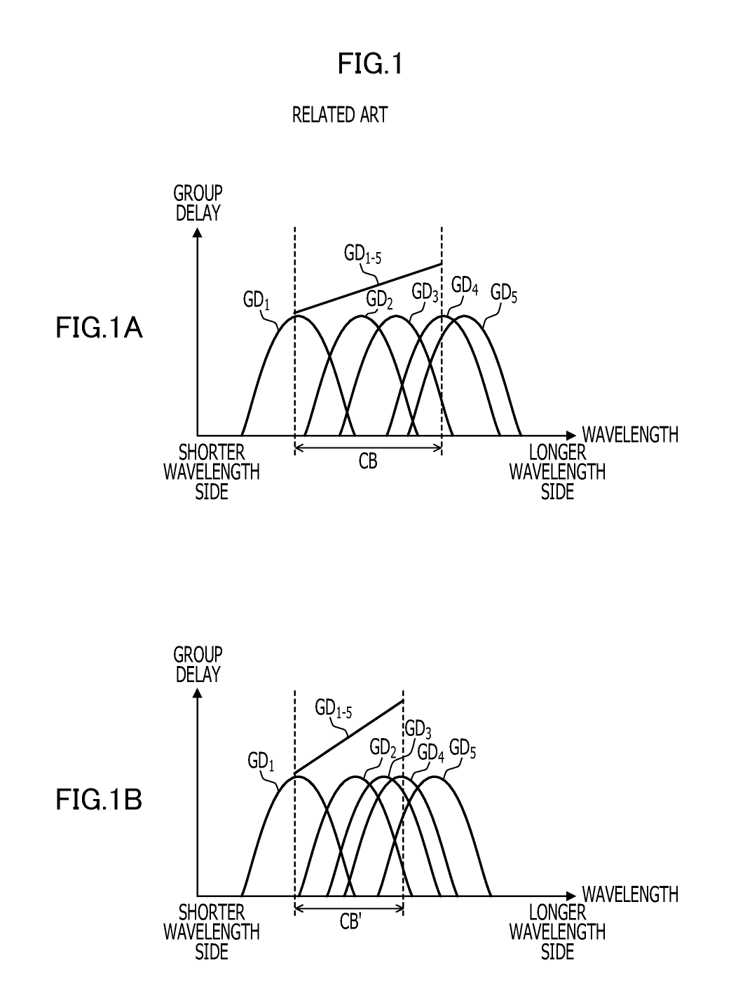

### DETAILED DESCRIPTION

Reference will now be made in detail to the embodiments, examples of which are illustrated in the accompanying drawings, wherein like reference numerals refer to the like elements throughout. The embodiments are described below to explain the present invention by referring to the figures.

Embodiments of the present invention will herein be described in detail with reference to the attached drawings.

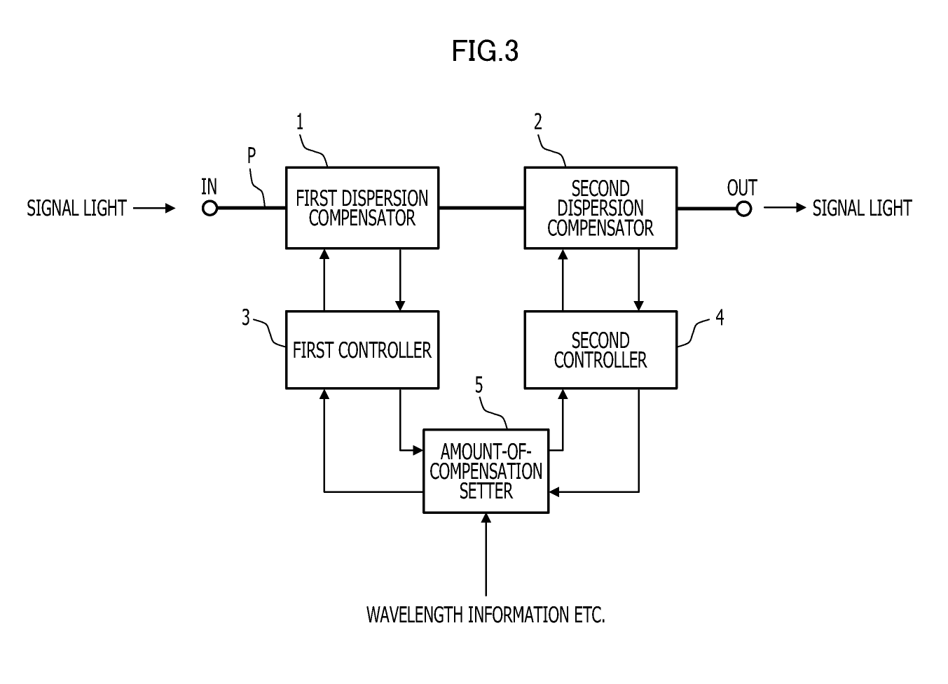

FIG. 3 illustrates an example of the arrangement of a tunable dispersion compensation apparatus according to an embodiment of the present invention.

Referring to FIG. 3, the tunable dispersion compensation apparatus 100 of an embodiment includes, for example, a first dispersion compensator 1, a second dispersion compensator 2, a first controller 3, a second controller 4, and an amount-of-compensation setter 5. The first dispersion compensator 1 and the second dispersion compensator 2 are arranged in series on an optical path P between an input port IN and an output port OUT. The first controller 3 controls an amount of dispersion compensation in the first dispersion compensator 1. The second controller 4 controls an amount of dispersion compensation and the dispersion compensation band in the second dispersion compensator 2. The amount-of-compensation setter 5 identifies an amount of dispersion compensation to be set in the entire tunable dispersion compensation apparatus based on external information to issue instructions to the first and second dispersion compensators 1 and 2. The first controller 3, the second controller 4, the amount-of-compensation setter 5 each function as a controller.

The first dispersion compensator 1 performs chromatic dispersion compensation to a bandwidth including a center wavelength of the spectrum of signal light input through the input port IN. The first dispersion compensator 1 has a variable amount of dispersion compensation, as in the tunable dispersion compensation apparatus described above, and has characteristics in that the dispersion compensation band in which group delays are linearly varied with respect to the wavelength is narrowed with the increasing absolute value of the amount of dispersion compensation that is set. The first dispersion compensator 1 preferably has an arrangement including those in which multiple known dispersion compensation elements are connected in series to each other along the optical path P of the signal light so that the variable width of the amount of dispersion compensation is increased both in the positive direction and in the negative direction. Preferred examples of the multiple dispersion compensation elements include Etalons and elements using a dielectric multilayer film or a planar lightwave circuit (PLC), which each have relatively small insertion loss and group delay ripples. However, the dispersion compensation elements used in the first dispersion compensator 1 are not limited to the above examples.

The second dispersion compensator 2 performs the chromatic dispersion compensation to a bandwidth including at least one of a shorter wavelength end and a longer wavelength end of the spectrum of the signal light input through the input port IN. The second dispersion compensator 2 has a variable amount of dispersion compensation and has an arrangement in which the dispersion compensation band can be varied independently of the amount of dispersion compensation. The second dispersion compensator 2 includes at least one dispersion compensation element that is the same as the one in the first dispersion compensator 1 or that is different from the one in the first dispersion compensator 1. The dispersion compensation element is arranged at the output side of the first dispersion compensator 1 in the example in FIG. 3. The second dispersion compensator 2 may be arranged at the input side of the first dispersion compensator 1. The first dispersion compensator 1 and the second dispersion compensator 2 may be arranged in an arbitrary order on the optical path P of the signal light.

The first controller 3 controls the amount of dispersion compensation in the first dispersion compensator 1 in accordance with the instruction from the amount-of-compensation setter 5. The second controller 4 controls the amount of dispersion compensation and the dispersion compensation band in the second dispersion compensator 2 in association with the amount of dispersion compensation set in the first dispersion compensator 1 in accordance with the instruction from the amount-of-compensation setter 5. How the first dispersion compensator 1 and the second dispersion compensator 2 are controlled by the first controller 3 and the second controller 4, respectively, is described in detail below.

The amount-of-compensation setter 5 externally receives, for example, information such as wavelength information about the signal light input through the input port IN and information about the transmission line on which the signal light is propagated to identify the value of chromatic dispersion to be compensated in the entire tunable dispersion compensation apparatus based on the received information. Then, the amount-of-compensation setter 5 determines the value of the amount of dispersion compensation to be set for the first dispersion compensator 1 and the values of the amount of dispersion compensation and the dispersion compensation band to be set for the second dispersion compensator 2 in accordance with the identified chromatic dispersion value and supplies the setting values to the corresponding first and second controllers 3 and 4.

An exemplary operation of the tunable dispersion compensation apparatus according to an embodiment of the present invention will now be described.

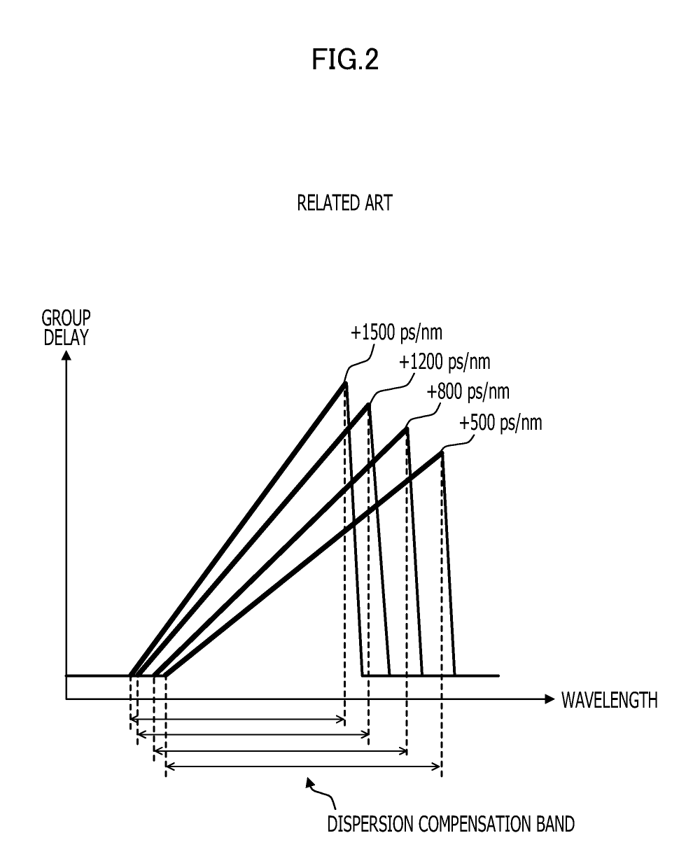

In the tunable dispersion compensation apparatus having the above arrangement, upon identification of the chromatic dispersion value to be compensated in the entire tunable dispersion compensation apparatus for the signal light input through the input port IN based on the external information by the amount-of-compensation setter 5, the amount of dispersion compensation to be set for the first dispersion compensator 1 in association with the chromatic dispersion value is determined. Upon determination of the amount of dispersion compensation in the first dispersion compensator 1, the dispersion compensation band of the first dispersion compensator 1 corresponding to the amount of dispersion compensation is determined from the relationship between the amount of dispersion compensation and the dispersion compensation band in the first dispersion compensator 1, like the relationship illustrated in FIG. 2. It is possible to identify the relationship between the amount of dispersion compensation and the dispersion compensation band in the first dispersion compensator 1 in advance based on the determined kind and arrangement of the dispersion compensation elements used in the first dispersion compensator 1.

If the dispersion compensation band of the first dispersion compensator 1 is narrower than a desired bandwidth based on the spectrum width of the signal light, the amount of dispersion compensation and the dispersion compensation band in the second dispersion compensator 2 are determined so that an amount of shortage of the dispersion compensation band is compensated by the second dispersion compensator 2. In other words, the amount of dispersion compensation and the dispersion compensation band to be set for the second dispersion compensator 2 are optimized in association with the amount of dispersion compensation to be set for the first dispersion compensator 1 so that a desired dispersion compensation band is realized by the combination of the first dispersion compensator 1 and the second dispersion compensator 2. If the dispersion compensation band corresponding to the amount of dispersion compensation to be set for the first dispersion compensator 1 is not narrower than the desired bandwidth, the amount of dispersion compensation in the second dispersion compensator 2 is set to 0 ps/nm.

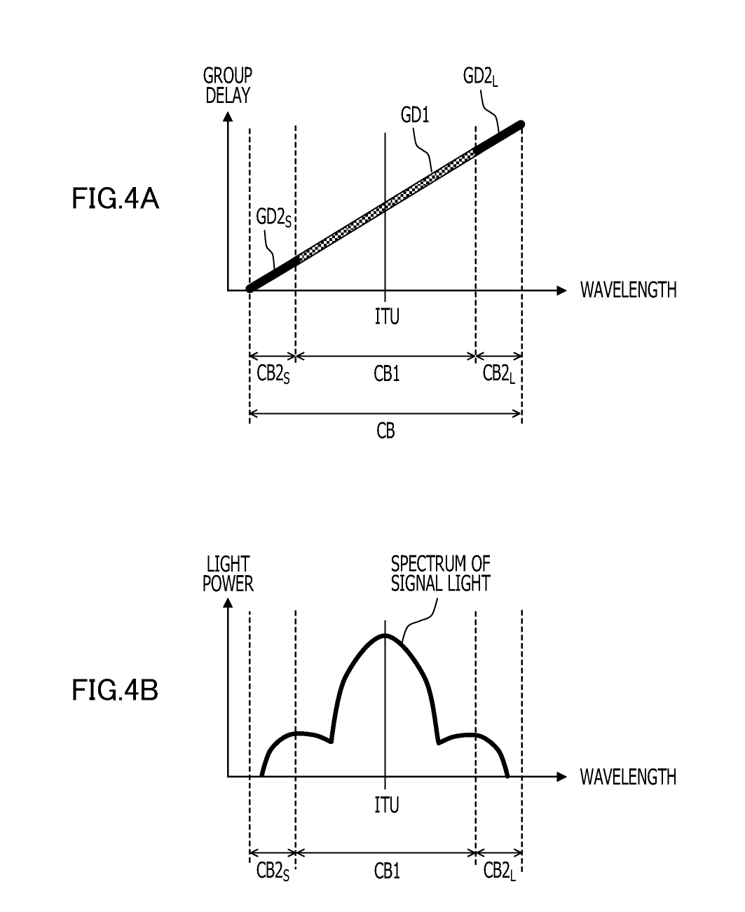

FIG. 4A illustrates exemplary group delay characteristics of the first dispersion compensator 1 and the second dispersion compensator 2. FIG. 4B illustrates an example of a relationship between dispersion compensation bands of the first dispersion compensator 1 and the second dispersion compensator 2 and the spectrum of signal light. In the examples in FIGS. 4A and 4B, a dispersion compensation band CB1 corresponding to the amount of dispersion compensation (the gradient of a group delay characteristic GD1) to be set for the first dispersion compensator 1 includes the center wavelength of the signal light conforming to, for example, an International Telecommunication Union (ITU) standard but is narrower than the spectrum width of the signal light. Specifically, the dispersion compensation band CB1 of the first dispersion compensator 1 has no component corresponding to the spectrum components of the shorter wavelength end and the longer wavelength end of the signal light. Accordingly, dispersion compensation bands CB2_{S} and CB2_{L} of the second dispersion compensator 2 are set so as to be adjacent to both ends of the dispersion compensation band CB1 of the first dispersion compensator 1 to make a dispersion compensation band CB resulting from addition of the dispersion compensation band CB1, the dispersion compensation band CB2_{S}, and the dispersion compensation band CB2_{L} wider than the spectrum width of the signal light. In this case, group delay characteristics GD2_{S} and GD2_{L} of the second dispersion compensator 2 are set so that the group delay characteristics in the first dispersion compensator 1 (the group delay characteristics that are outside the dispersion compensation band CB1 and that are not linear) are offset and the gradients of the group delay characteristics become close to the gradient of the group delay characteristic GD1 within the dispersion compensation band CB1 in the first dispersion compensator 1.

Upon determination of the values to be set for the first dispersion compensator 1 and the second dispersion compensator 2 in the above manner by the amount-of-compensation setter 5, the setting values are supplied to the corresponding first controller 3 and second controller 4, which control the first dispersion compensator 1 and the second dispersion compensator 2, respectively. Accordingly, the chromatic dispersion compensation of the signal light input through the input port IN is performed in accordance with the combination of the group delay characteristics of the first dispersion compensator 1 and the second dispersion compensator 2.

With the tunable dispersion compensation apparatus of an embodiment, the amount of dispersion compensation and the dispersion compensation band in the second dispersion compensator 2 are controlled in association with the amount of dispersion compensation to be set for the first dispersion compensator 1 even if the absolute value of the amount of dispersion compensation is increased to narrow the dispersion compensation band of the first dispersion compensator 1, so that the desired dispersion compensation band wider than the spectrum width of the signal light is ensured in the entire tunable dispersion compensation apparatus. As a result, it is possible to realize the tunable dispersion compensation apparatus that supports high-speed signal light and that has a larger variable width of the amount of dispersion compensation.

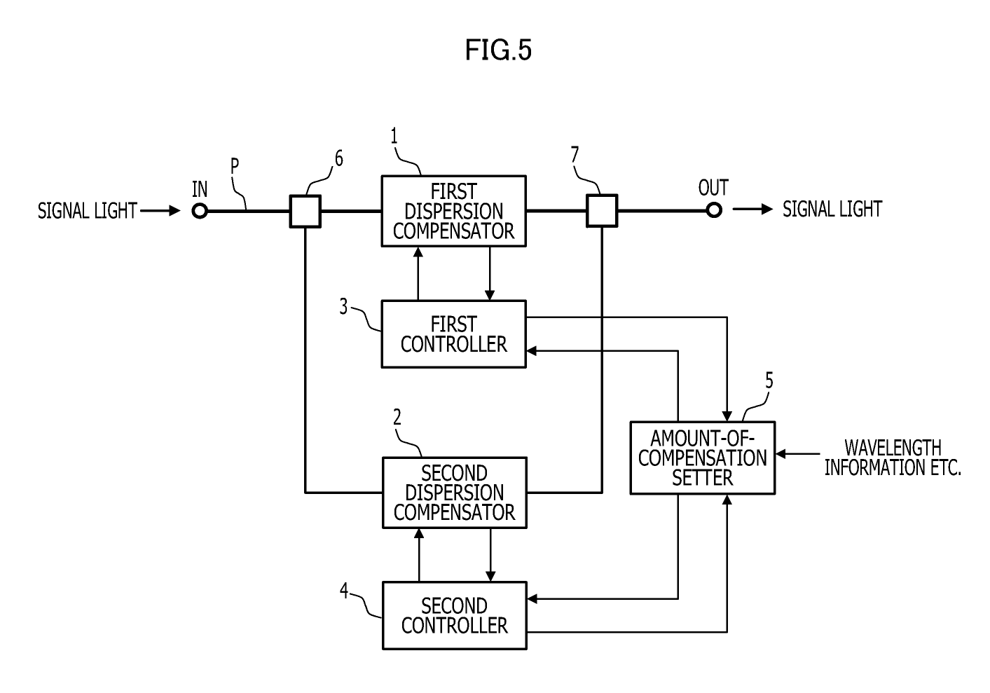

Although the arrangement in which the first dispersion compensator 1 and the second dispersion compensator 2 are arranged in series on the optical path P between the input port IN and the output port OUT is described in an embodiment, the first dispersion compensator 1 and the second dispersion compensator 2 may be arranged in parallel by using, for example, a demultiplexer 6 and a multiplexer 7 as in an example illustrated in FIG. 5.

In the arrangement illustrated in FIG. 5, the signal light input through the input port IN is demultiplexed into a component corresponding to the dispersion compensation band of the first dispersion compensator 1 and a component corresponding to the dispersion compensation band of the second dispersion compensator 2 in the demultiplexer 6 and the components resulting from the demultiplexing are supplied to the first dispersion compensator 1 and the second dispersion compensator 2. The components subjected to the dispersion compensation in the first dispersion compensator 1 and the second dispersion compensator 2 are multiplexed in the multiplexer 7 and the resulting signal light is output through the output port OUT. It is assumed here that the demultiplexing characteristics of the demultiplexer 6 and the multiplexing characteristics of the multiplexer 7 are variably controlled in association with the amount of dispersion compensation to be set for the first dispersion compensator 1, as in the dispersion compensation band of the second dispersion compensator 2.

A tunable dispersion compensation apparatus according to an embodiment of the present invention will now be described.

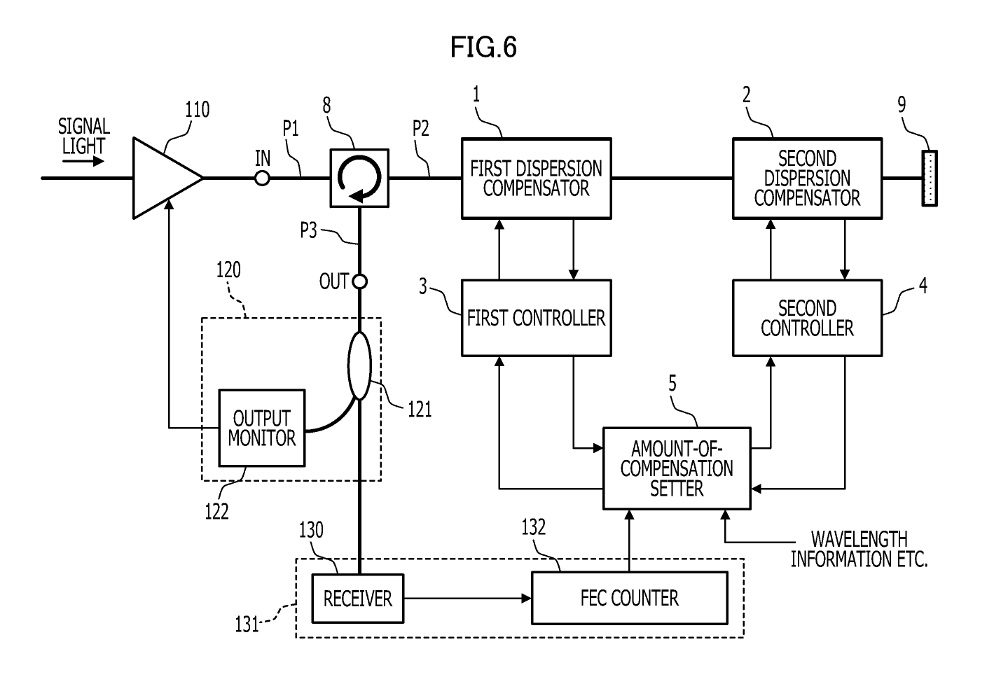

FIG. 6 illustrates an example of the arrangement of an optical reception module to which the tunable dispersion compensation apparatus of an embodiment is applied.

Referring to FIG. 6, the tunable dispersion compensation apparatus of an embodiment is of a reflective type in which an optical circulator 8 and a reflection mirror 9 are provided, in addition to the components in an embodiment. The optical circulator 8 is provided on the optical path P between the input port IN and the first dispersion compensator 1, and the reflection mirror 9 is provided at the output side of the second dispersion compensator 2. The optical reception module using the tunable dispersion compensation apparatus of an embodiment includes, for example, an optical amplifier 110 upstream of the input port IN of the tunable dispersion compensation apparatus and an output monitor unit 120 and an optical receiver unit 130 downstream of the output port OUT of the tunable dispersion compensation apparatus.

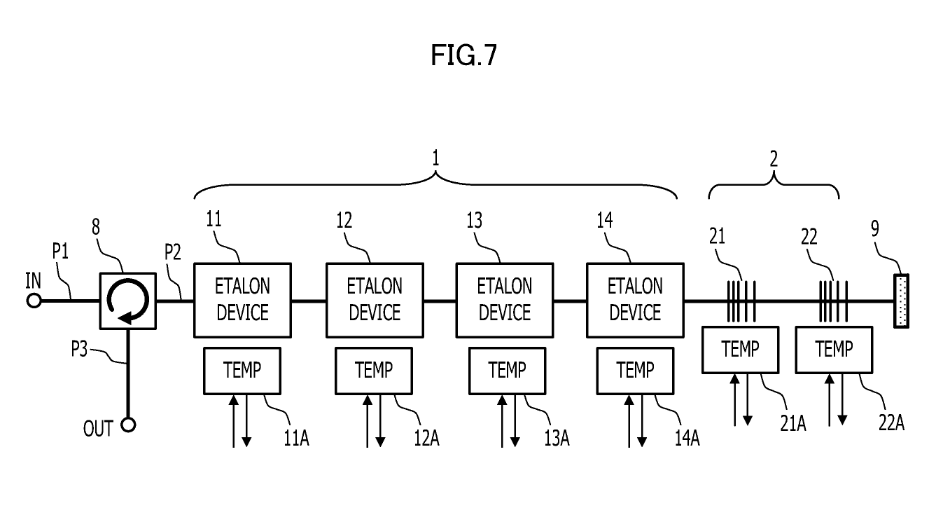

FIG. 7 specifically illustrates an example of an arrangement of a tunable dispersion compensation apparatus in FIG. 6.

Referring to FIG. 7, the optical circulator 8 includes three ports P1, P2, and P3. The port P1 is connected to the input port IN, the port P2 is connected to the first dispersion compensator 1, and the port P3 is connected to the output port OUT. The optical circulator 8 has a characteristic in that light beams are transmitted in fixed directions between the ports. Specifically, a light beam input through the port P1 is supplied to the port P2 and a light beam input through the port P2 is supplied to the port P3. A popular optical coupler and a popular optical isolator may be combined to realize a function similar to that of the optical circulator 8.

The first dispersion compensator 1 includes multiple Etalon devices that are arranged in series on the optical path connected to the port P2 of the optical circulator 8. In the example in FIG. 7, the first dispersion compensator 1 includes four Etalon devices 11, 12, 13, and 14. The Etalon devices 11, 12, 13, and 14 include temperature control circuits (TEMPS) 11A, 12A, 13A, and 14A, respectively. The temperature control circuits 11A to 14A adjust the temperatures of the Etalon devices 11 to 14, respectively, in accordance with control signals supplied from the first controller 3 (refer to FIG. 6) to vary the amount of dispersion compensation in the first dispersion compensator 1. The dispersion compensation band of the first dispersion compensator 1 realized by the combination of the Etalon devices 11 to 14 is designed so as to include the center wavelength (for example, an ITU grid wavelength) of signal light input through the input port IN with the varied amount of dispersion compensation.

The second dispersion compensator 2 includes at least one Fiber Bragg Grating (FBG) part on the optical path on which the signal light sequentially passing through the Etalon devices 11 to 14 in the first dispersion compensator 1 is propagated. In the example in FIG. 7, the second dispersion compensator 2 includes two FBG parts 21 and 22 that are arranged in series. Each of the FBG parts 21 and 22 achieves the function of a reflective filter by periodically varying the refractive index of a certain part along the longitudinal direction of the optical path to form grating where Bragg diffraction is caused. Specifically, each of the FBG parts 21 and 22 gradually varies the pitch of the grating (Bragg diffraction) to vary the time during which the reflected light is returned in accordance with the wavelength in order to cause the chromatic dispersion. The dispersion compensation band of the second dispersion compensator 2 is designed so as to include wavelength regions near the shorter wavelength end and the longer wavelength end of the spectrum of the signal light input through the input port IN. In the example in FIG. 7, the dispersion compensation band of the FBG part 21 covers the wavelength region near the shorter wavelength end of the spectrum of the signal light, and the dispersion compensation band of the FBG part 22 covers the wavelength region near the longer wavelength end of the spectrum of the signal light. Since the principle of the operation and characteristics of the chromatic dispersion compensator using the fiber grating are described in detail in, for example, “Jisedai Kousoku Tsushin You Bunsan Hoshyo Fiber Grating (Next-generation High-speed Communication Dispersion Compensation Fiber Grating)” Fujikura-Gihou, April 2004, No. 106, a description of them is omitted herein.

The FBG parts 21 and 22 also include temperature control circuits (TEMPS) 21A and 22A, respectively, as in the Etalon devices 11 to 14. The temperature control circuits 21A and 22A adjust the temperatures of the FBG parts 21 and 22, respectively, in accordance with control signals supplied from the second controller 4 (refer to FIG. 6) to vary the amount of dispersion compensation and the dispersion compensation band in the second dispersion compensator 2.

The reflection mirror 9 reflects the signal light passing through the second dispersion compensator 2, that is, the signal light having a wavelength outside the dispersion compensation band of the second dispersion compensator 2. The reflected light is returned to the second dispersion compensator 2 and passes through the second dispersion compensator 2 and the first dispersion compensator 1 in the backward direction, which is opposite to the forward direction.

The optical amplifier 110 (refer to FIG. 6) in the optical reception module amplifies the signal light input into the optical reception module and supplies the amplified signal light to the input port IN of the tunable dispersion compensation apparatus. The gain of the optical amplifier 110 is controlled so that the power of the signal light detected in the output monitor unit 120 has a constant level that is set in advance.

The output monitor unit 120 includes a branching device 121 and an output monitor 122. The output monitor unit 120 branches part of the signal light output through the output port OUT of the tunable dispersion compensation apparatus as monitor light with the branching device 121 and detects the power of the monitor light with the output monitor 122 to supply a signal indicating the detected power to the optical amplifier 110.

The optical receiver unit 130 includes a receiver 131 and an FEC counter 132. The optical receiver unit 130 receives the signal light that is output through the output port OUT of the tunable dispersion compensation apparatus and passes through the branching device 121 with the receiver 131. The receiver 131 performs common data reproduction processing to the received signal light. In the example in FIG. 6, forward error correction (FEC) using known error correcting codes is performed as the data reproduction processing in the receiver 131 and the count of errors detected in the FEC is supplied to the FEC counter 132. The FEC counter 132 numbers the count of errors detected within a predetermined time and supplies a signal indicating the count value to the amount-of-compensation setter 5 in the tunable dispersion compensation apparatus.

The optical reception module using the tunable dispersion compensation apparatus is provided on each of the optical paths on which the demultiplexed signal light beams having a single wavelength are propagated in, for example, the optical reception apparatus that demultiplexes the WDM signal light transmitted on the optical path and receives the demultiplexed WDM signal light. However, the usage of the optical reception module is not limited to the above one.

An exemplary operation of the tunable dispersion compensation apparatus according to an embodiment of the present invention will now be described.

In the tunable dispersion compensation apparatus having the arrangement illustrated in FIG. 7, upon identification of the chromatic dispersion value to be compensated in the entire tunable dispersion compensation apparatus for the signal light input through the input port IN based on the external information by the amount-of-compensation setter 5, the amounts of dispersion compensation to be set for the Etalon devices 11 to 14 in the first dispersion compensator 1 in association with the chromatic dispersion value are determined. The amounts of dispersion compensation are set in consideration of the fact that the dispersion compensation of the signal light in each of the Etalon devices 11 to 14 is performed not only in the forward direction (the rightward direction in FIG. 7) but also in the backward direction (the leftward direction in FIG. 7). Specifically, since the dispersion compensation in the first dispersion compensator 1 is performed in the forward direction and the backward direction, the absolute value of the amount of dispersion compensation to be set for the first dispersion compensator 1 is decreased, compared with the case in which the dispersion compensation is performed only in either the forward direction or the backward direction. Accordingly, narrowing of the dispersion compensation band caused by the increase in the absolute value of the amount of dispersion compensation is suppressed to enable the dispersion compensation having a larger variable width. In addition, since the number of the Etalon devices connected in series to each other is reduced because of the dispersion compensation of the signal light in the forward direction and the backward direction, it is possible to reduce the size of the tunable dispersion compensation apparatus.

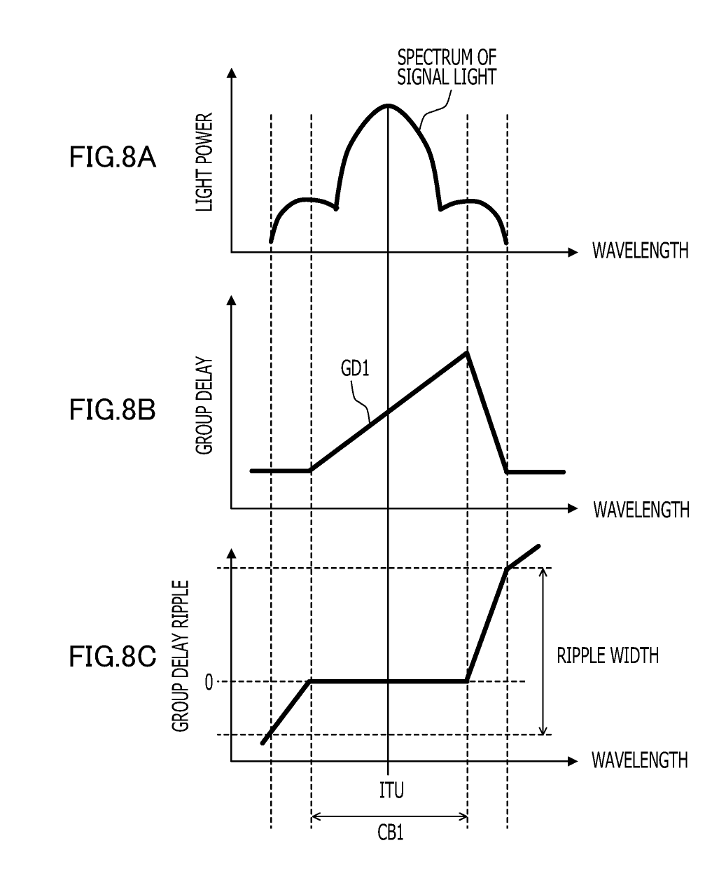

Upon determination of the amount of dispersion compensation in the first dispersion compensator 1 corresponding to the dispersion compensation of the signal light in the forward direction and the backward direction, the dispersion compensation band of the first dispersion compensator 1 corresponding to the amount of dispersion compensation is determined from the relationship between the amount of dispersion compensation and the dispersion compensation band in the first dispersion compensator 1 (refer to FIG. 2). FIGS. 8A, 8B and 8C illustrate exemplary group delay characteristics and group delay ripple characteristics of the first dispersion compensator 1 corresponding to a certain amount of dispersion compensation. A group delay characteristic GD1 of the first dispersion compensator 1 illustrated in FIG. 8B is set so that the center wavelength of the spectrum of the signal light conforming to the ITU standard, illustrated in FIG. 8A, is matched with a substantial center of a dispersion compensation band CB1 in which the group delay characteristic is linearly varied. However, the dispersion compensation band CB1 of the first dispersion compensator 1 is narrower than the spectrum width of the signal light and, as illustrated in FIG. 8C, positive and negative group delay ripples occur in the wavelength regions outside the dispersion compensation band CB1. Accordingly, the dispersion compensation only in the first dispersion compensator 1 results in the signal light having group delay ripples of a larger width. The group delay ripples mean slightly vibrating components represented as the differences from the linear approximation of the group delay characteristics. The precise of the dispersion compensation is reduced with the increasing vibration width of the group delay ripples.

In the setting of the amount of dispersion compensation in the first dispersion compensator 1 illustrated in FIGS. 8A, 8B and 8C, the dispersion compensation bands of the FBG parts 21 and 22 in the second dispersion compensator 2 are determined so that the amount of shortage of the dispersion compensation band in the first dispersion compensator 1 is compensated and the amounts of dispersion compensation in the FBG parts 21 and 22 are determined so that the group delay characteristics of the first dispersion compensator 1 within the dispersion compensation band are offset to realize a desired chromatic dispersion value.

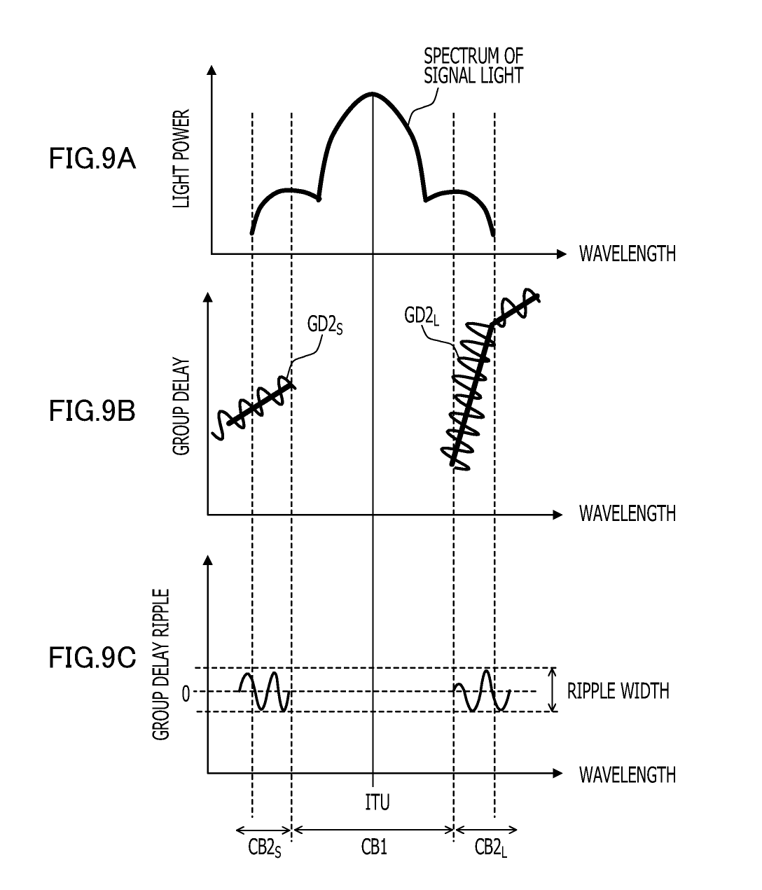

FIGS. 9A, 9B and 9C illustrate exemplary group delay characteristics and group delay ripple characteristics of the second dispersion compensator 2 corresponding to the examples in FIGS. 8A, 8B and 8C. A dispersion compensation band CB2_{S} of the FBG part 21 in the second dispersion compensator 2 is set so as to be adjacent to the shorter wavelength end of the dispersion compensation band CB1 of the first dispersion compensator 1 and to include the shortest wavelength component of the spectrum of the signal light, as illustrated in FIG. 9B, with respect to the center wavelength of the spectrum of the signal light conforming to the ITU standard, illustrated in FIG. 9A. A group delay characteristics GD2_{S} of the FBG part 21 is set so that the average gradient of the group delay characteristics GD2_{S} becomes close to the gradient of the group delay characteristic GD1 of the first dispersion compensator 1 within the dispersion compensation band CB1. In contrast, a dispersion compensation band CB2_{L} of the FBG part 22 in the second dispersion compensator 2 is set so as to be adjacent to the longer wavelength end of the dispersion compensation band CB1 of the first dispersion compensator 1 and to include the longest wavelength component of the spectrum of the signal light. A group delay characteristics GD2_{L} of the FBG part 22 is set so that the group delay characteristics of the first dispersion compensator 1 corresponding to the dispersion compensation band CB2_{L} are offset to make the average gradient of the group delay characteristics GD2_{L} close to the gradient of the group delay characteristic GD1 of the first dispersion compensator 1 within the dispersion compensation band CB1.

The group delay ripples are likely to occur in the group delay characteristics GD2_{S} of the FBG part 21 and the group delay characteristics GD2_{L} of the FBG part 22, compared with the group delay characteristic GD1 in the combination of the Etalon devices 11 to 14. This is because the reflective structure is formed by using a periodic variation in the refractive index in the FBG and it is difficult to reduce the ripple components because of, for example, a variation in the strength of an exposure laser and/or a shift in the position between optical fiber and a phase mask during exposure in the manufacturing process. In FIGS. 9B and 9C, wavy lines are used to schematically illustrate occurrences of the group delay ripples in the FBG parts 21 and 22. In the graph in FIG. 9B, the amount of shift of the wavy lines from bold lines representing the average gradients of the group delay characteristics GD2_{S} and the group delay characteristics GD2_{L} corresponds to the amount of the group delay ripples that has occurred. Accordingly, as illustrated in FIG. 9C, the width of the group delay ripples occurring in the entire second dispersion compensator 2 is narrower than the width of the group delay ripples in the first dispersion compensator 1, illustrated in FIG. 8C.

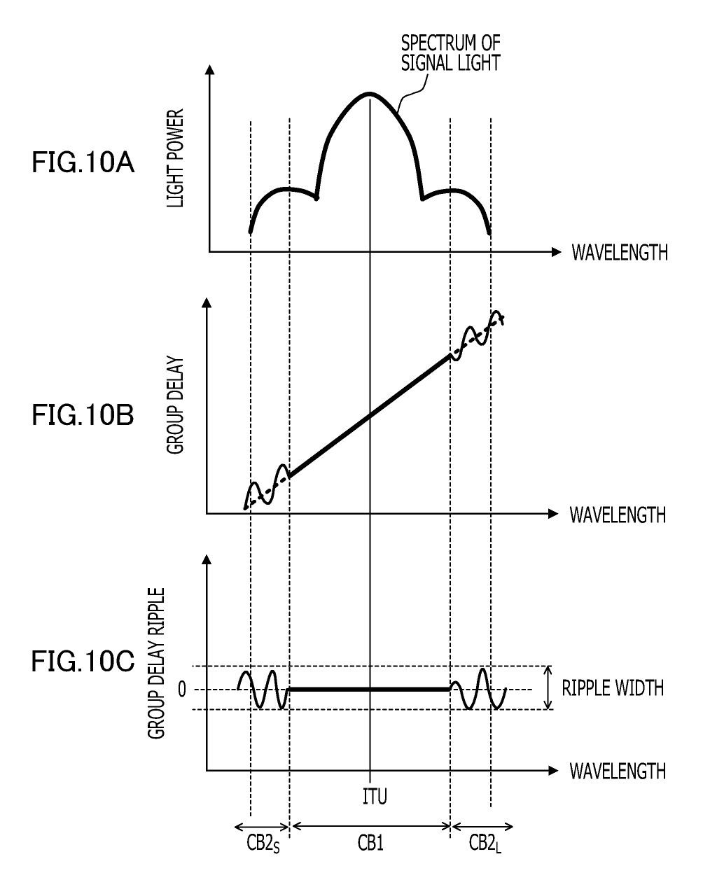

FIGS. 10A, 10B and 100 illustrate exemplary group delay characteristics and group delay ripple characteristics in the entire tunable dispersion compensation apparatus, corresponding to the combination of the examples in FIGS. 8A, 8B and 8C and FIGS. 9A, 9B and 9C. As apparent from the graphs in FIGS. 10A, 10B and 100, the first dispersion compensator 1 and the second dispersion compensator 2 can be combined to ensure a dispersion compensation band CB1+CB2_{S}+CB2_{L} wider than the spectrum width of the signal light and to effectively suppress the group delay ripples occurring within the dispersion compensation band.

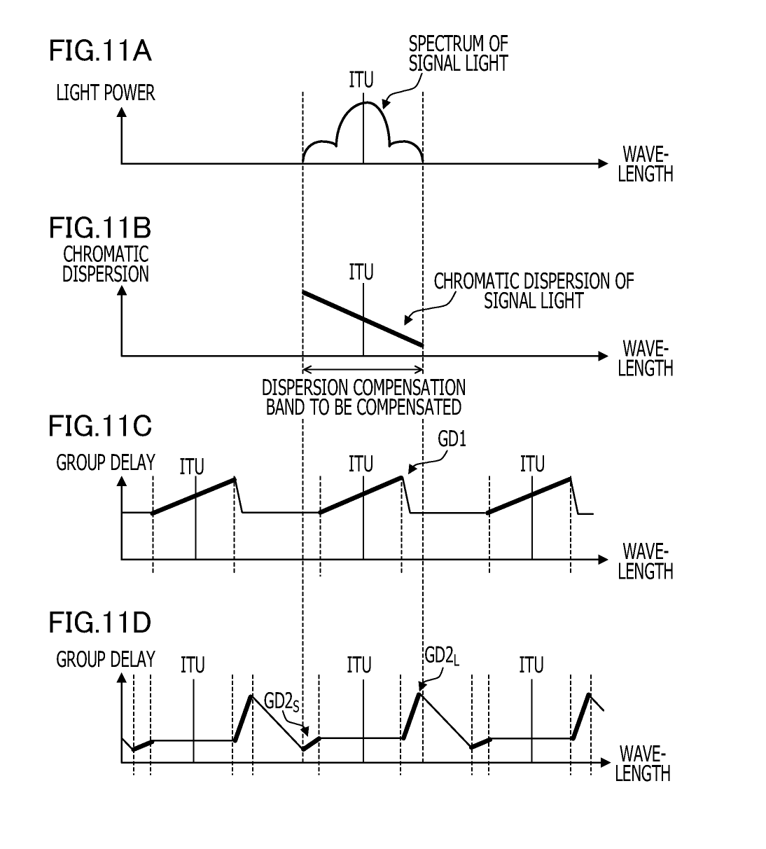

Although the characteristics of the first dispersion compensator 1 and the second dispersion compensator 2 with respect to one signal light beam conforming to the ITU standard are described above with reference to FIGS. 8A, 8B and 8C, FIGS. 9A, 9B and 9C, and FIGS. 10A, 10B and 100, the tunable dispersion compensation apparatus of an embodiment can be used to perform the dispersion compensation with respect to multiple signal light beams on an ITU grid because the group delay characteristic GD1 of the first dispersion compensator 1 and the group delay characteristics GD2_{S} and the group delay characteristics GD2_{L} of the second dispersion compensator 2 has periodicity, as illustrated in FIGS. 11A, 11B, 11C and 11D.

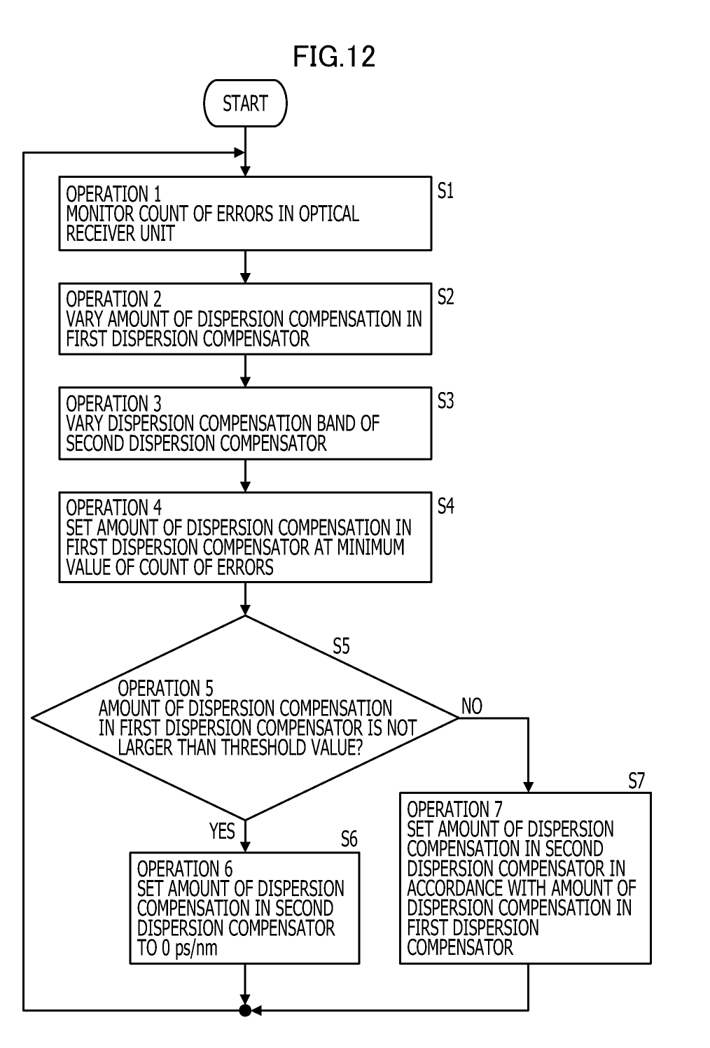

The settings in the first dispersion compensator 1 and the second dispersion compensator 2, described above, can be made while monitoring the reception characteristics of the signal light processed in the optical receiver unit 130 (the count of errors in the FEC in the example in FIG. 6) when the tunable dispersion compensation apparatus is applied to the optical reception module illustrated in FIG. 6. An example of a setting operation in the first dispersion compensator 1 and the second dispersion compensator 2 in the optical reception module in FIG. 6 will now be described with reference to FIG. 12.

Referring to FIG. 12, in the optical reception module, after incident signal light is received by the receiver 131 in the optical receiver unit 130 through the optical amplifier 110 and the tunable dispersion compensation apparatus that are initialized, in Operation 1, the value of the count of errors detected in the FEC is indicated from the FEC counter 132 to the amount-of-compensation setter 5 in the tunable dispersion compensation apparatus. The indication of the count value from the FEC counter 132 to the amount-of-compensation setter 5 is successively performed on a certain detection cycle.

In Operation 2, the amount-of-compensation setter 5 in the tunable dispersion compensation apparatus receives the count value from the FEC counter 132 and issues an instruction to vary the amount of dispersion compensation in the first dispersion compensator 1 so as to reduce the count value to the first controller 3. If the dispersion compensation band corresponding to the varied amount of dispersion compensation in the first dispersion compensator 1 is overlapped with the dispersion compensation band of the second dispersion compensator 2, then in Operation 3, the amount-of-compensation setter 5 issues an instruction to vary the dispersion compensation band of the second dispersion compensator 2 to the second controller 4 to cause the dispersion compensation band of the first dispersion compensator 1 not to be overlapped with that of the second dispersion compensator 2.

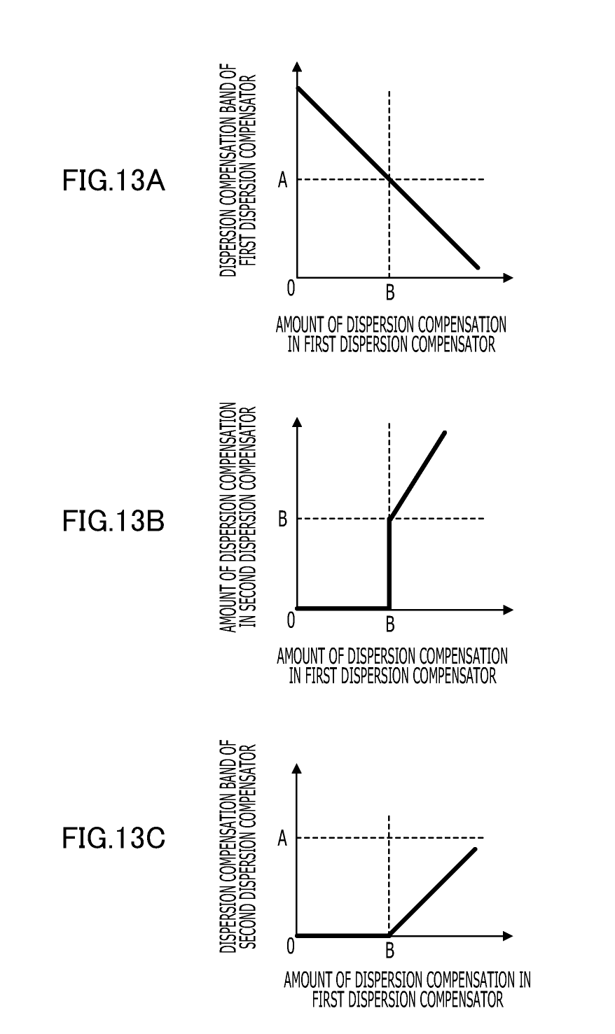

The amount-of-compensation setter 5 confirms the count value from the FEC counter 132 in a state in which the first dispersion compensator 1 and the second dispersion compensator 2 are stably controlled by the first controller 3 and the second controller 4, respectively, and repeats Operations 2 and 2 until a minimum count value is acquired. In Operation 4, the amount-of-compensation setter 5 sets the amount of dispersion compensation in the first dispersion compensator 1 when the minimum count value is acquired as an optimal value. In Operation 5, the amount-of-compensation setter 5 determines whether the absolute value of the optimal value of the amount of dispersion compensation in the first dispersion compensator 1 is not larger than a predetermined threshold value. An amount of dispersion compensation B corresponding to a lower limit A within the dispersion compensation band may be set as the threshold value used in the determination by using, for example, the relationship between the amount of dispersion compensation in the first dispersion compensator 1 and the dispersion compensation band of the first dispersion compensator 1, schematically illustrated in FIG. 13A. The lower limit A within the dispersion compensation band is based on, for example, the spectrum width of the signal light and/or the transmission performance of a system to which the optical reception module is applied.

If an optimal value (the absolute value) of the amount of dispersion compensation in the first dispersion compensator 1 is not larger than the threshold value B, that is, if the dispersion compensation band CB1 of the first dispersion compensator 1 is equal to the lower limit A or is wider than the lower limit A, then in Operation 6, the amount-of-compensation setter 5 issues an instruction to set the amount of dispersion compensation in the second dispersion compensator 2 to 0 ps/nm to the second controller 4. If the optimal value (the absolute value) of the amount of dispersion compensation in the first dispersion compensator 1 is larger than the threshold value B, that is, if the dispersion compensation band CB1 of the first dispersion compensator 1 is narrower than the threshold value B, then in Operation 7, the amount-of-compensation setter 5 issues an instruction to set the amount of dispersion compensation in the second dispersion compensator 2 so that the group delay characteristics of the first dispersion compensator 1 are offset to realize the amount of dispersion compensation equivalent to the optimal value also within the dispersion compensation band CB2_{S} and the dispersion compensation band CB2_{L} of the second dispersion compensator 2 to the second controller 4.

With the above process, if the amount of dispersion compensation to be set for the first dispersion compensator 1 is not larger than the threshold value B, as illustrated in FIG. 13B, the amount of dispersion compensation in the second dispersion compensator 2 is set to 0 ps/nm regardless of the amount of dispersion compensation in the first dispersion compensator 1. In contrast, if the amount of dispersion compensation to be set for the first dispersion compensator 1 is larger than the threshold value B, the amount of dispersion compensation in the second dispersion compensator 2 is set in accordance with the amount of dispersion compensation in the first dispersion compensator 1. The dispersion compensation band of the second dispersion compensator 2 is set to no dispersion compensation (the second dispersion compensator 2 is operated at 0 ps/nm), as illustrated in FIG. 13C, if the amount of dispersion compensation to be set for the first dispersion compensator 1 is not larger than the threshold value B. The dispersion compensation band of the second dispersion compensator 2 is expanded so as to compensate the narrowed dispersion compensation band of the first dispersion compensator 1 if the amount of dispersion compensation in the first dispersion compensator 1 is larger than the threshold value B.

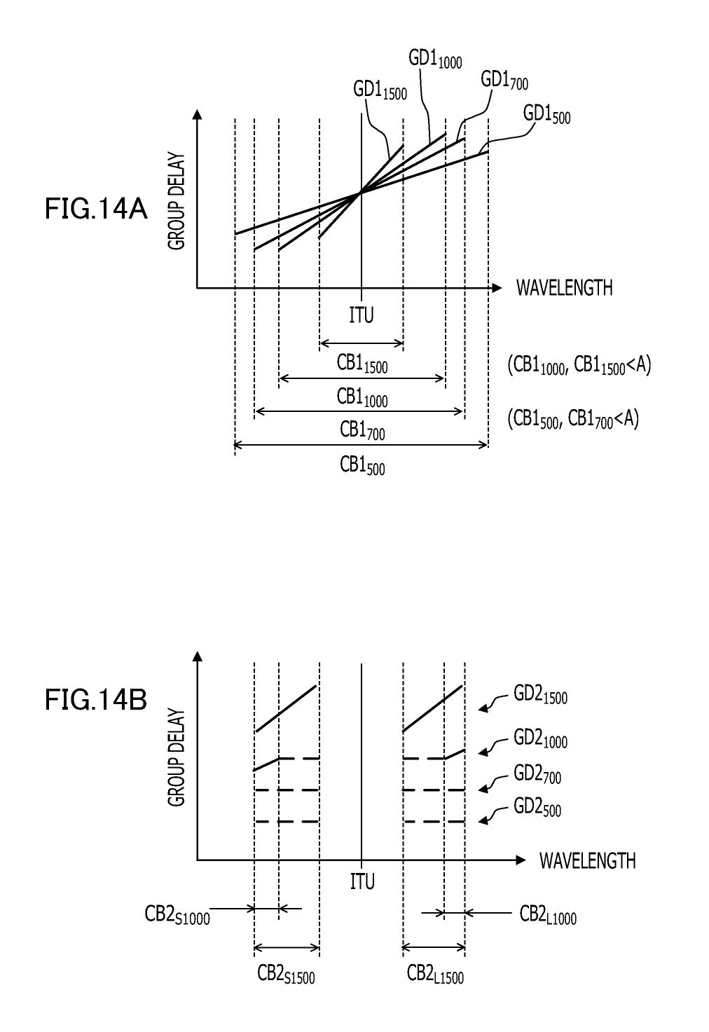

FIGS. 14A and 14B illustrate an example of the relationship between the group delay characteristics and the dispersion compensation bands in the first dispersion compensator 1 and the second dispersion compensator 2 when the amount of dispersion compensation in the first dispersion compensator 1 is set to values in a range from +500 ps/nm to +1,500 ps/nm. In the example in FIGS. 14A and 14B, when the amount of dispersion compensation to be set for the first dispersion compensator 1 is +700 ps/nm or smaller, a dispersion compensation band CB1₅₀₀ and a dispersion compensation band CB1₇₀₀ of the first dispersion compensator 1 are set so as to be wider than the lower limit A within the dispersion compensation band described above. Accordingly, the gradients of a group delay characteristic GD2₅₀₀ and a group delay characteristic GD2₇₀₀ of the second dispersion compensator 2 corresponding to the case in which the amount of dispersion compensation to be set for the first dispersion compensator 1 is +700 ps/nm or smaller are set to zero (0 ps/nm).

When the amount of dispersion compensation to be set for the first dispersion compensator 1 reaches +1,000 ps/nm, a dispersion compensation band CB1₁₀₀₀ of the first dispersion compensator 1 falls short both at the shorter wavelength side and at the longer wavelength side. Accordingly, in the FBG parts 21 and 22 in the second dispersion compensator 2, a dispersion compensation band CB2S₁₀₀₀ of the FBG part 21 is optimized so as to compensate the amount of shortage at the shorter wavelength side and a dispersion compensation band CB2L₁₀₀₀ of the FBG part 22 is optimized so as to compensate the amount of shortage at the longer wavelength side. A group delay characteristic GD2₁₀₀₀ of the second dispersion compensator 2 is set so that the gradients within the dispersion compensation band CB2S₁₀₀₀ and the dispersion compensation band CB2L₁₀₀₀ are equal to +1,000 ps/nm. In the examples in FIGS. 14A and 14B, the group delay characteristic GD1 of the first dispersion compensator 1 outside the dispersion compensation band CB1 is ignored (the gradient is set to zero) for simplification.

When the amount of dispersion compensation to be set for the first dispersion compensator 1 is increased to +1,500 ps/nm, the amounts of shortage of a dispersion compensation band CB1₁₅₀₀ of the first dispersion compensator 1 are increased both at the shorter wavelength side and the longer wavelength side. Accordingly, the dispersion compensation band of the FBG part 21 in the second dispersion compensator 2 is expanded to a dispersion compensation band CB2_{S1500} and the dispersion compensation band of the FBG part 22 in the second dispersion compensator 2 is expanded to a dispersion compensation band CB2_{L1500} in accordance with the increase in the amounts of shortage. A group delay characteristic GD2₁₅₀₀ of the second dispersion compensator 2 is set so that the gradients within the dispersion compensation band CB2_{S1500} and the dispersion compensation band CB2_{L1500} are equal to +1,500 ps/nm.

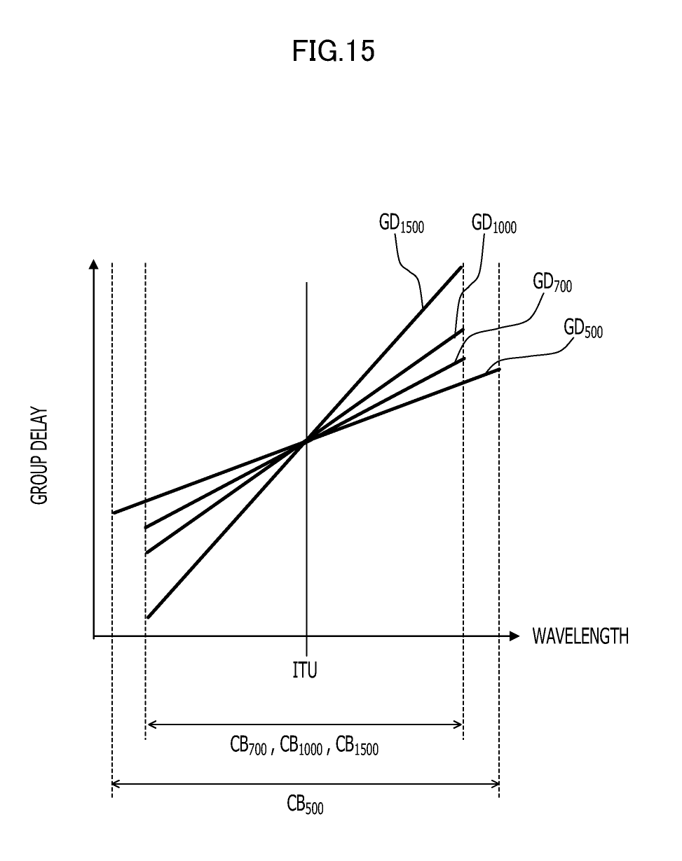

FIG. 15 illustrates an example of the relationship in the entire tunable dispersion compensation apparatus between the group delay characteristics, resulting from the combination of the group delay characteristics of the first dispersion compensator 1 and the second dispersion compensator 2 illustrated in FIGS. 14A and 14B, and the dispersion compensation bands. As apparent from FIG. 15, even if the amount of dispersion compensation in the entire tunable dispersion compensation apparatus is varied, bandwidths wider than the lower limit A are ensured as dispersion compensation bands CB₅₀₀, CB₇₀₀, CB₁₀₀₀, and CB₁₅₀₀ for the respective amounts of dispersion compensation.

Table 1 indicates exemplary specific numerical values corresponding to FIGS. 14A and 14B and FIG. 15. In Table 1, the lower limit A of the dispersion compensation band is set to 40 GHz and the threshold value of the amount of dispersion compensation is set to 700 ps/nm.

TABLE 1

| | | Second dispersion compensator | | | |
|---|---|---|---|---|---|
| | | | Dispersion | | |
| First dispersion compensator | | | compensation | | Dispersion |
| Amount of | Dispersion | Amount of | band | | compensation band in |
| dispersion | compensation | dispersion | [GHz] | | entire tunable dispersion |
| compensation | band | compensation | FBG | FBG | compensation apparatus |
| [ps/nm] | [GHz] | [ps/nm] | part 21 | part 22 | [GHz] |
| 500 | 45 | 0 | 0 | 0 | 45 |
| 700 | 40 | 0 | 0 | 0 | 40 |
| 1,000 | 30 | 1,000 | 5 | 5 | 40 |

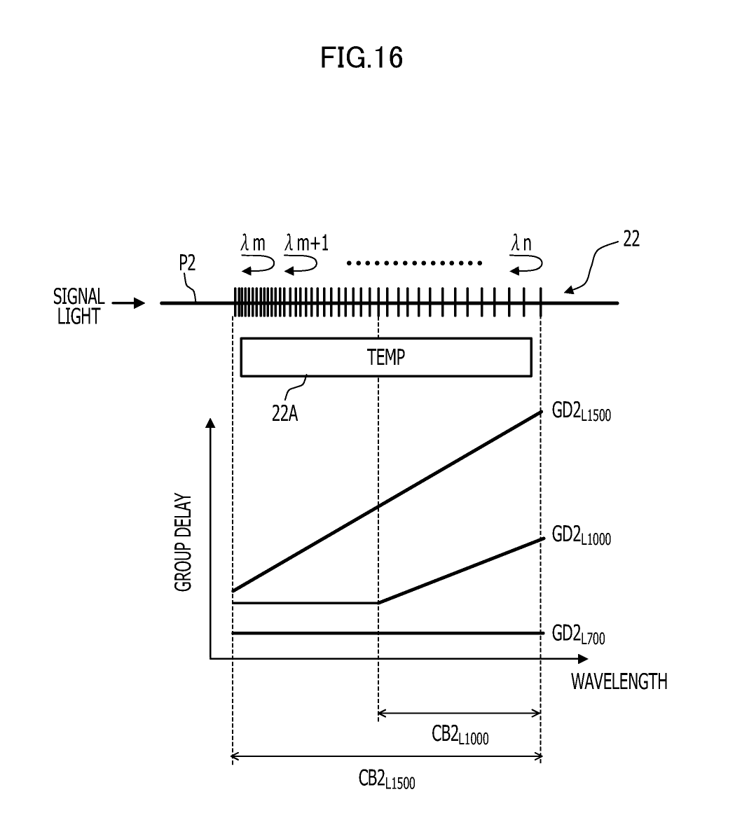

An operation to control the second dispersion compensator 2 by the second controller 4 will now be specifically described in accordance with the relationship between the group delay characteristic and the dispersion compensation bands of the second dispersion compensator 2, illustrated in FIG. 14B. FIG. 16 illustrates an example of a control operation in the FBG part 22 corresponding to the longer wavelength side. A control operation in the FBG part 21 corresponding to the shorter wavelength side is similar to the control operation in the FBG part 22.

In general, in the dispersion compensation using the FBG, the temperature can be adjusted in accordance with the position of the FBG in the longitudinal direction to control the temperature gradient or a stress to be applied to the FBG can be controlled to vary the amount of dispersion compensation or the dispersion compensation band. For example, temperature characteristics of FBG are described in detail in “Takashi Yokouchi et al., “Ni-dankai-houshiki Ni Yoru Fiber Grating No Ondo Hoshyo (Temperature Compensation of Fiber Grating in Two-stage Method)”, The Institute of Electronics, Information and Communication Engineers (IEICE) Transaction C Vol. J87-C, No. 9 pp. 696 to 702, 2004″. In addition, a variation in characteristics of FBG by stress application is described in detail in “Kazuhiko Terasawa et al., “Hikari Fiber Grating Wo Mochiita Hizumi Sensing You Cable Kouzou Ni Kansuru Kento (Study of Structure of Distortion Sensing Cable Using Optical Fiber Grating)”, Mitsubishi Cable Industries, LTD. Jihou, No. 98, October 2001, pp. 18 to 22″ and “Takeshi Genchi el al., “Fiber Grating Ni Yoru Hikari Cable Nai Hizumi Bunpu Sokutei (Measurement of Distribution of Distortion in Optical Cable by Fiber Grating)”, Mitsubishi Cable Industries, LTD. Jihou, No. 96, February 2000, pp. 49 to 53″. In the examples illustrated in FIGS. 7 and 16, the temperature gradient of the FBG part 22 is controlled by the temperature control circuit 22A to vary the amount of dispersion compensation and the dispersion compensation band in the FBG part 22.

When the amount of dispersion compensation in the first dispersion compensator 1 is set to +1,000 ps/nm in the same manner as in the example in FIGS. 14A and 14B for the FBG part 22, the spectrum components of the signal light reflected by the FBG part 22 are limited to the dispersion compensation band CB2L₁₀₀ and the temperature gradient of the FBG part 22 is controlled so that the gradient of a group delay characteristic GD2_{L1000} within the dispersion compensation band CB2L₁₀₀₀ becomes close to +1,000 ps/nm. When the amount of dispersion compensation in the first dispersion compensator 1 is set to +1,500 ps/nm, the spectrum components of the signal light reflected by the FBG part 22 are expanded to the dispersion compensation band CB2_{L1500} and the temperature gradient of the FBG part 22 is controlled so that the gradient of a group delay characteristic GD2_{L1500} within the dispersion compensation band CB2_{L1500} becomes close to +1,500 ps/nm. In contrast, when the amount of dispersion compensation in the first dispersion compensator 1 is set to +700 ps/nm, there is no spectrum component of the signal light reflected by the FBG part 22, that is, the temperature gradient of the FBG part 22 is controlled so that the amount of dispersion compensation in the FBG part 22 is equal to 0 ps/nm.

With the tunable dispersion compensation apparatus according to an embodiment described above, even if the spectrum width of the signal light is increased due to an increase in speed of the signal light, the amounts of dispersion compensation and the dispersion compensation bands of the FBG part 21 and the FBG part 22 in second dispersion compensator 2 can be appropriately set in association with the amount of dispersion compensation to be set for the first dispersion compensator 1 to perform the chromatic dispersion compensation to the signal light over a wide variable range with a high precision. In addition, since the tunable dispersion compensation apparatus of an embodiment has the arrangement in which the use of the optical circulator 8 and the reflection mirror 9 allows the signal light to pass through the first dispersion compensator 1 both in the forward direction and the backward direction, the amount of dispersion compensation of a larger absolute value can be acquired by connecting a small number of the Etalon devices in series, thus realizing a compact tunable dispersion compensation apparatus having a large variable width. Furthermore, since the FBG part 21 and the FBG part 22 applied to the second dispersion compensator 2 each have a mounting size and an insertion loss smaller than those of the Etalon devices and the reflection characteristics (the reflection wavelength and the amount of reflection) within a narrower bandwidth can be advantageously realized with a high precision, it is possible to realize a more compact tunable dispersion compensation apparatus with a high performance. The application of the above tunable dispersion compensation apparatus to the optical reception module and the optimization of the setting values in the first dispersion compensator 1 and the second dispersion compensator 2 in the tunable dispersion compensation apparatus while monitoring the reception characteristics of the signal light processed in the optical receiver unit 130 allow the high-speed signal light to be subjected to the chromatic dispersion compensation with a high precision and to be reliably received.

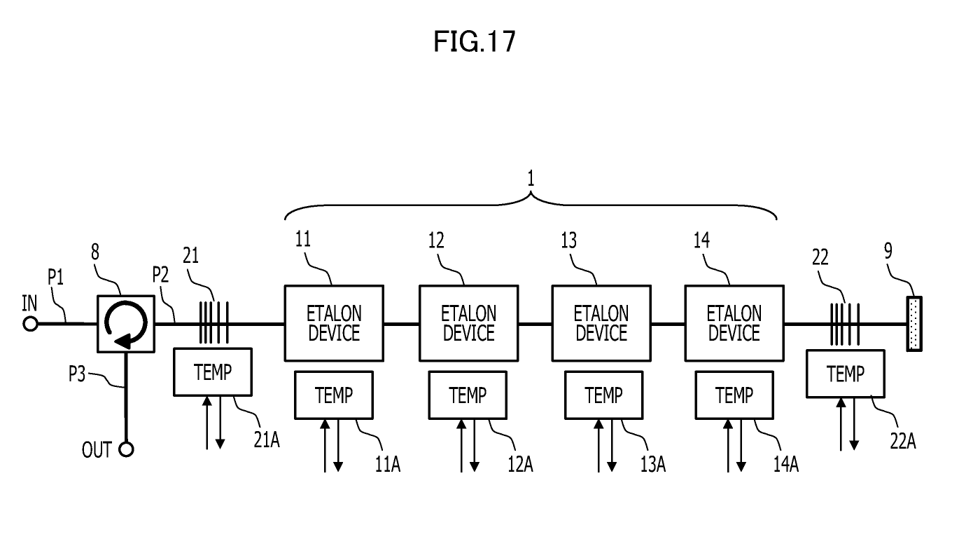

Although the exemplary arrangement in which the FBG part 21 and the FBG part 22 in the second dispersion compensator 2 are arranged on the optical path between the first dispersion compensator 1 and the reflection mirror 9 (refer to FIG. 7) is described in an embodiment, either of the FBG part 21 and the FBG part 22 may be arranged on the optical path between the optical circulator 8 and the first dispersion compensator 1, as illustrated in FIG. 17 where the FBG part 21 is arranged on the optical path between the optical circulator 8 and the first dispersion compensator 1. Alternatively, both of the FBG part 21 and the FBG part 22 may be arranged on the optical path between the optical circulator 8 and the first dispersion compensator 1, although now illustrated. Since the dispersion compensation bands of the FBG part 21 and the FBG part 22 are set so as not to be overlapped with the dispersion compensation band of the first dispersion compensator 1, as described above, the spectrum components of the signal light outside the dispersion compensation band of the FBG part pass through the FBG part to be supplied to the first dispersion compensator 1 even if the FBG part is arranged at the input side of the first dispersion compensator 1. Accordingly, it is possible to achieve the operational advantages as in an embodiment regardless of the arrangement of the FBG part 21 and the FBG part 22 with respect to the first dispersion compensator 1.

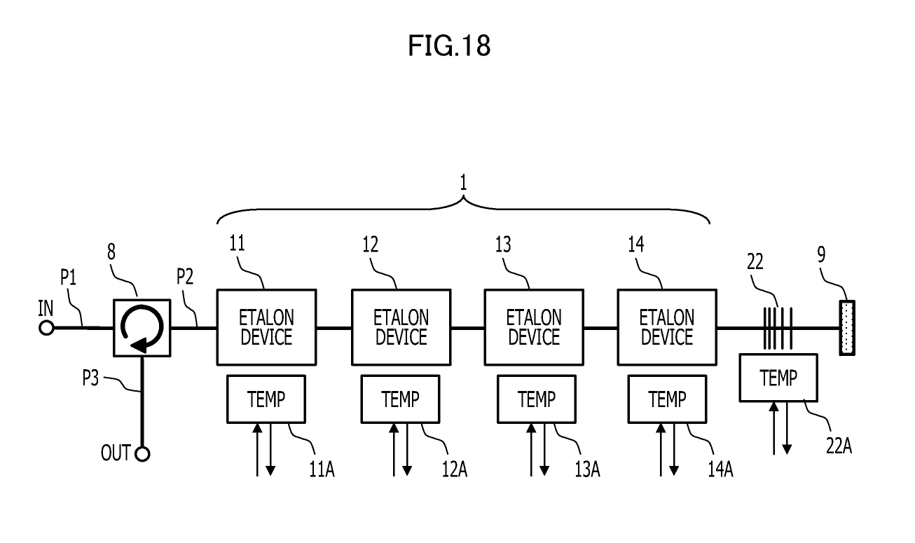

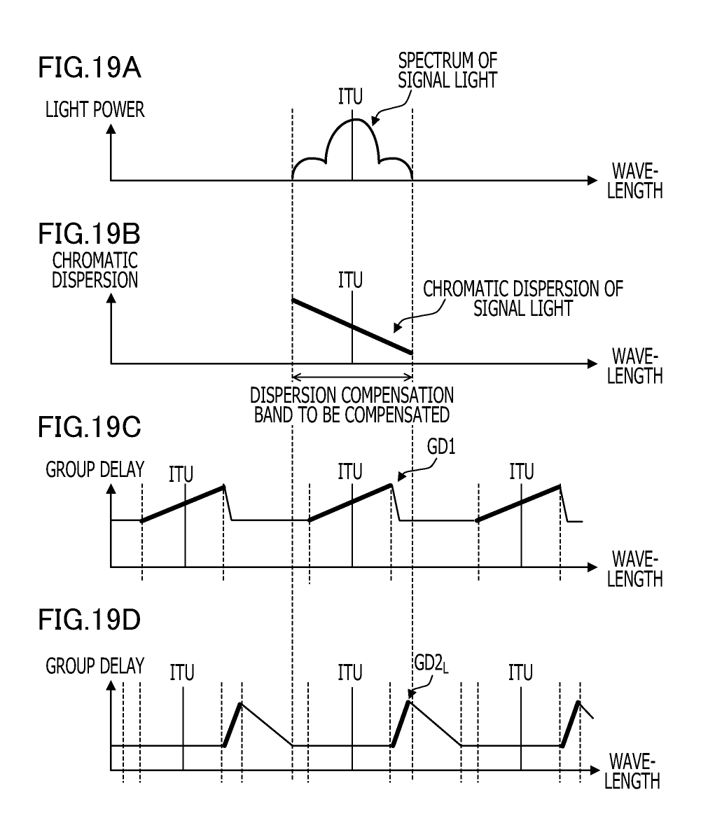

The exemplary arrangement in which the FBG part 21 corresponding to the shorter wavelength side and the FBG part 22 corresponding to the longer wavelength side are arranged in series so that the amounts of shortage of the dispersion compensation band of the first dispersion compensator 1 both at the shorter wavelength side and at the longer wavelength side are compensated by the dispersion compensation band of the second dispersion compensator 2 is described in an embodiment. However, for example, as illustrated in the arrangement of a tunable dispersion compensation apparatus in FIG. 18 and group delay characteristics GD1 and GD2_{L} of the first dispersion compensator and the second dispersion compensator in FIGS. 19A, 19B, 19C and 19D, only the bandwidth having a greater group delay ripple of the first dispersion compensator 1 (the bandwidth at the longer wavelength side in FIG. 18 and FIGS. 19A, 19B, 19C and 19D) may be selected from the bandwidths at the shorter wavelength side and the longer wavelength side and the selected bandwidth may be subjected to the dispersion compensation by the second dispersion compensator 2 (the FBG part 22). Although the precision of the chromatic dispersion compensation of the signal light is slightly reduced in this case, compared with an embodiment, the precision is sufficiently improved, compared with a case in which only the first dispersion compensator 1 is used to perform the chromatic dispersion compensation to signal light.

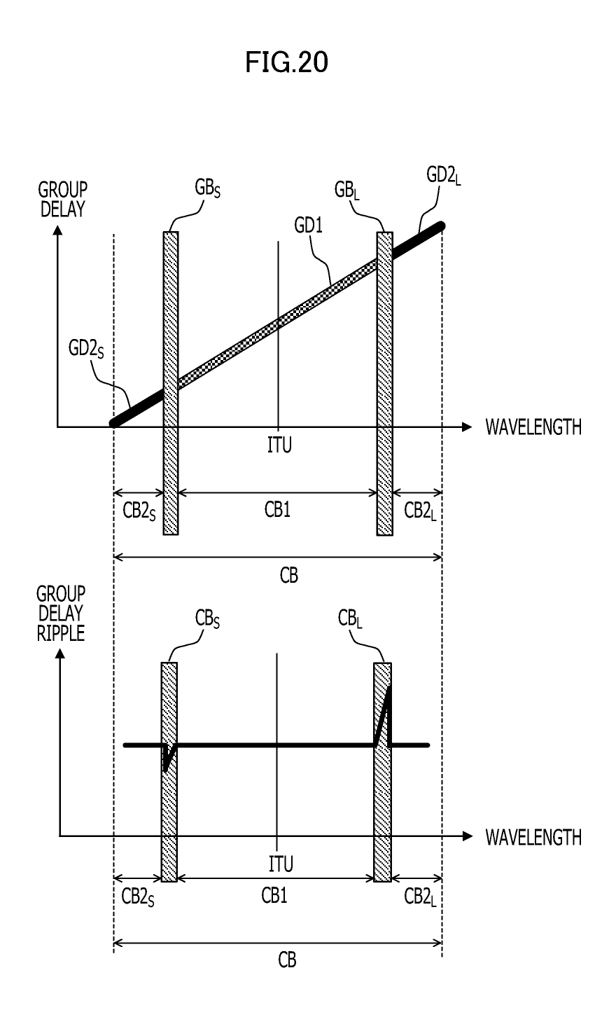

Although the case in which the dispersion compensation bands of the second dispersion compensator 2 are set so as to be adjacent to both ends of the dispersion compensation band of the first dispersion compensator 1 is described in an embodiment, guard bands GB_{S} and GB_{L} where the dispersion compensation is not performed may be provided near both ends of the dispersion compensation band CB1 of the first dispersion compensator 1, as illustrated in FIG. 20. In this case, the dispersion compensation bands CB2_{S} and CB2_{L} of the second dispersion compensator 2 are set so as to be apart from both ends of the dispersion compensation band CB1 of the first dispersion compensator 1 by the amount corresponding to the guard bands. Specifically, the amounts of dispersion compensation of the second dispersion compensator 2 corresponding to the guard bands GB_{S} and GB_{L} are set to 0 ps/nm. The provision of the guard bands GB_{S} and GB_{L} prevents an occurrence of a large group delay ripple caused by the dispersion compensation bands that are overlapped with each other due to manufacture errors of the first dispersion compensator 1 and the second dispersion compensator 2. Since the guard bands GB_{S} and GB_{L} themselves are sufficiently narrower than the dispersion compensation band of the entire tunable dispersion compensation apparatus, it is possible to further improve the precision of the chromatic dispersion compensation because of the effect of the prevention of the above group delay ripple.

An application example concerning the optical reception module (refer to FIG. 6) will now be described.

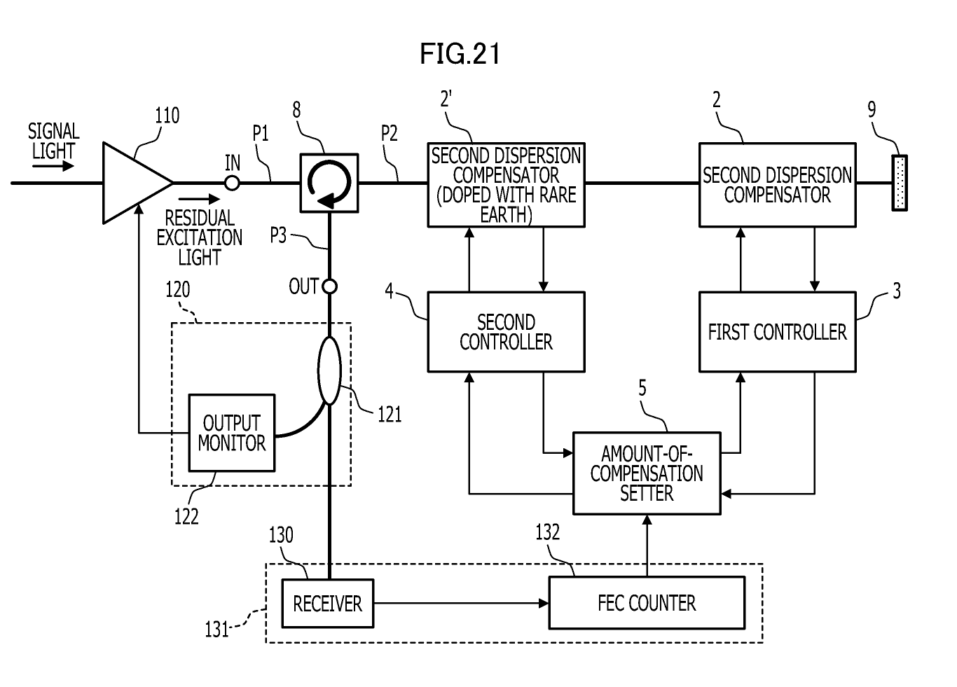

FIG. 21 illustrates the arrangement of an application example of an optical reception module to which a tunable dispersion compensation apparatus is applied.

In the application example in FIG. 21, a second dispersion compensator 2′ is applied, instead of the second dispersion compensator 2 in the tunable dispersion compensation apparatus of an embodiment. The second dispersion compensator 2′ functions as an optical amplification medium by doping rare-earth ion on the optical path on which signal light is propagated. The second dispersion compensator 2′ is arranged between the optical circulator 8 and the first dispersion compensator 1. The components in the optical reception module, excluding the second dispersion compensator 2′, are the same as in the arrangement in FIG. 6.

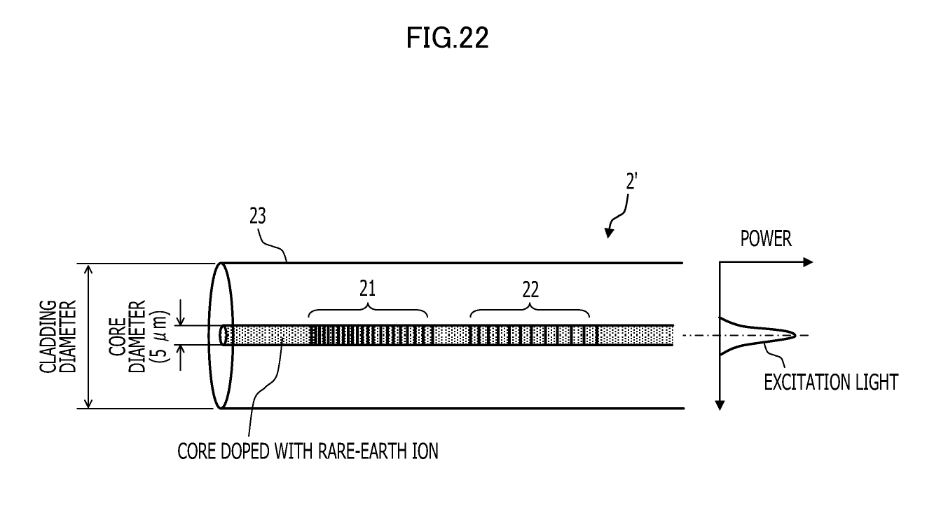

In the second dispersion compensator 2′, for example, the core of optical fiber 23 in which the FBG part 21 and the FBG part 22 are formed is doped with rare-earth ion at a certain density, as illustrated in FIG. 22. The optical fiber 23 having the core doped with the rare-earth ion has a core diameter (for example, 5 μm) smaller than the core diameter (normally 10 μm) of single mode fiber (SMF) used in common FBG. The optical fiber having a smaller core diameter is used because the rare-earth ion doped in a central part of the optical fiber is efficiently overlapped with excitation light having a wavelength shorter than that of signal light. The residual excitation light of the optical amplifier 110 may be used as the excitation light when a forward-excitation rare-earth doped optical fiber amplifier is applied as the optical amplifier 110 connected to the input port IN of the tunable dispersion compensation apparatus. Specifically, the residual excitation light output through the output port of the optical amplifier 110 is led to the optical fiber 23 through the optical circulator 8 to excite the rare-earth ion in the core. An example of the intensity distribution of the excitation light along a cross-sectional direction of the optical fiber 23 is illustrated on the right part in FIG. 22. The intensity distribution indicates that the excitation light is concentrated in the core. Accordingly, a desired gain is realized with the optical path of a shorter length.

In the optical reception module having the above arrangement, the second dispersion compensator 2′ in the tunable dispersion compensation apparatus has both the function of the dispersion compensation medium and the function of the optical amplification medium and the residual excitation light of the optical amplifier 110 is used to amplify the signal light also in the second dispersion compensator 2′. Accordingly, it is possible to efficiently amplify the received signal light.

Although the optical path (the optical fiber 23) in which the FBG part 21 and the FBG part 22 in the second dispersion compensator 2′ are formed is doped with the rare-earth ion in the above application example of the optical reception module, for example, the optical path connecting the Etalon devices in the first dispersion compensator 1 may be doped with the rare-earth ion to cause the first dispersion compensator 1 to function as the optical amplification medium. Although the residual excitation light of the optical amplifier 110 is used to amplify the signal light in the second dispersion compensator 2′, an excitation-light source supplying the excitation light to the second dispersion compensator 2′ may be separately provided.

With the tunable dispersion compensation apparatus described above, even if an absolute value of an amount of dispersion compensation to be set for the first dispersion compensator is increased to narrow the dispersion compensation band of the first dispersion compensator, the controller is used to control the amount of dispersion compensation and the dispersion compensation band in the second dispersion compensator in association with the amount of dispersion compensation in the first dispersion compensator. Accordingly, the amount of shortage of the dispersion compensation band in the first dispersion compensator is compensated by the second dispersion compensator. Consequently, since a desired dispersion compensation band wider than the spectrum width of the signal light is ensured in the entire arrangement including the first dispersion compensator and the second dispersion compensator, it is possible to realize the tunable dispersion compensation apparatus that supports high-speed signal light and that has a larger variable width of the amount of dispersion compensation.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. An example of communication media includes a carrier-wave signal.

Further, according to an aspect of the embodiments, any combinations of the described features, functions and/or operations can be provided.

Although a few embodiments have been shown and described, it would be appreciated by those skilled in the art that changes may be made in these embodiments without departing from the principles and spirit of the invention, the scope of which is defined in the claims and their equivalents.

What is claimed is:

1. A tunable dispersion compensation apparatus, comprising:
a first dispersion compensator that is arranged on an optical path between an input port and an output port, that has a dispersion compensation band, and that substantially compensates a chromatic dispersion to signal light by using a variable amount of dispersion compensation;
a second dispersion compensator that is arranged on the optical path, that has a dispersion compensation band different from the dispersion compensation band of the first dispersion compensator, and that substantially compensates the chromatic dispersion to the signal light by using the variable amount of dispersion compensation; and
a controller that controls the first dispersion compensator in accordance with a value of chromatic dispersion to be compensated and that controls dispersion compensation band in the second dispersion compensator in association with an amount of dispersion compensation in the first dispersion compensator.

2. The tunable dispersion compensation apparatus according to claim 1, wherein, when an absolute value of the amount of dispersion compensation in the first dispersion compensator is larger than a predetermined threshold value, the controller controls the dispersion compensation band of the second dispersion compensator so as to be adjacent to at least one of a shorter wavelength end and a longer wavelength end of the dispersion compensation band of the first dispersion compensator and to include a shortest wavelength component or a longest wavelength compensation of a spectrum of the signal light.

3. The tunable dispersion compensation apparatus according to claim 2, wherein the controller controls the dispersion compensation band of the second dispersion compensator so as to be adjacent to an end at the side where a relatively large group delay ripple in the first dispersion compensator occurs, among the shorter wavelength end and the longer wavelength end of the dispersion compensation band of the first dispersion compensator.

4. The tunable dispersion compensation apparatus according to claim 2, wherein the controller controls the amount of dispersion compensation in the second dispersion compensator so as to be equal to a value corresponding to the amount of dispersion compensation in the first dispersion compensator when the absolute value of the amount of dispersion compensation in the first dispersion compensator is larger than the threshold value, and controls the amount of dispersion compensation in the second dispersion compensator so as to be close to 0 ps/nm when the absolute value of the amount of dispersion compensation in the first dispersion compensator is not larger than the threshold value.

5. The tunable dispersion compensation apparatus according to claim 2, wherein the absolute value of the amount of dispersion compensation in the first dispersion compensator, corresponding to a lower limit within the dispersion compensation band based on a spectrum width of the signal light, is set as the threshold value.

6. The tunable dispersion compensation apparatus according to claim 2, wherein the controller controls the dispersion compensation band of the second dispersion compensator so that a guard band where no dispersion compensation is performed is formed in a boundary between the dispersion compensation band of the first dispersion compensator and the dispersion compensation band of the second dispersion compensator.

7. The tunable dispersion compensation apparatus according to claim 1, wherein the first dispersion compensator and the second dispersion compensator are arranged in series on the optical path.

8. The tunable dispersion compensation apparatus according to claim 7, comprising:
an optical circulator that is arranged on the optical path and that includes a first port, a second and a third port; and
a reflection mirror that is arranged on the optical path and that reflects the signal light, and
wherein the first port of the optical circulator is connected with the input port, the second port thereof is connected with one end of an optical path passing through the first dispersion compensator and the second dispersion compensator, and the third port thereof is connected with the output port, and
wherein the reflection mirror is arranged at the other end of the optical path passing through the first dispersion compensator and the second dispersion compensator and reflects signal light through the first dispersion compensator and the second dispersion compensator to return the reflected signal light to the first dispersion compensator and the second dispersion compensator.

9. The tunable dispersion compensation apparatus according to claim 8, wherein the second dispersion compensator includes at least one Fiber Bragg Grating part and reflects a component outside the dispersion compensation band of the first dispersion compensator in a spectrum of signal light propagated on the optical path with the Fiber Bragg Grating part in accordance with the wavelength.

10. The tunable dispersion compensation apparatus according to claim 8, wherein the first dispersion compensator includes a plurality of Etalon devices connected in series to each other.

11. The tunable dispersion compensation apparatus according to claim 1, wherein the first dispersion compensator and the second dispersion compensator are arranged in parallel on the optical path along with a demultiplexer and a multiplexer.

12. An optical reception module including the tunable dispersion compensation apparatus according to claim 1.

13. The optical reception module according to claim 12, comprising:
an optical amplifier that amplifies signal light that is received to supply the amplified signal light to the tunable dispersion compensation apparatus; and
an optical receiver that receives signal light subjected to dispersion compensation in the tunable dispersion compensation apparatus to perform data reproduction processing to the received signal light, and
wherein the controller in the tunable dispersion compensation apparatus controls the amount of dispersion compensation in the first dispersion compensator and the amount of dispersion compensation and the dispersion compensation band in the second dispersion compensator in accordance with reception characteristics of the signal light processed in the optical receiver.

14. The optical reception module according to claim 13, comprising:
an output monitor that monitors a power of signal light output from the tunable dispersion compensation apparatus,
wherein the gain of the optical amplifier is controlled so that the power of the signal light monitored by the output monitor has a constant level.

15. The optical reception module according to claim 12, wherein, in the tunable dispersion compensation apparatus, at least part of the optical path passing through the first dispersion compensator and the second dispersion compensator is doped with rare-earth ion and excitation light exciting the rare-earth ion is applied to the optical path to amplify signal light passing through the optical path.

16. A method of controlling dispersion compensation, comprising:
arranging at least two compensators on an optical path that have different dispersion compensation bands; and
adjusting an amount of dispersion compensation and a dispersion compensation band in a second of the at least two compensators relative to an amount of dispersion compensation in a first of the at least two compensators.
